(19) United States
(12) Patent Application Publication
(10) Pub. No.: US 2026/0352576 A1
(43) Pub. Date: Nov. 5, 2026

(54) RECIPROCITY-BASED RESOURCE SELECTION AND REPORTING

(71) Applicant: Lenovo (United States) Inc., Morrisville, NC (US)

(72) Inventor: Vijay Nangia, Woodridge, IL (US)

(73) Assignee: Lenovo (United States) Inc., Morrisville, NC (US)

(21) Appl. No.: 19/637,623

(22) Filed: Apr. 2, 2026

(51) Int. Cl. H04L 43/062; H04B 7/0456; H04L 5/00; H04L 27/26

(52) U.S. Cl. CPC H04L 43/062; H04B 7/0456; H04L 5/0044; H04L 27/261

(57) ABSTRACT

Various aspects of the present disclosure relate to reciprocity-based resource selection and reporting. An apparatus, such as a user equipment (UE), transmits a capability message indicating a capability of the UE to support at least a partial downlink-uplink (DL-UL) reciprocity. Based on the capability, the UE receives a reporting configuration indicating a downlink reference signal configuration and a reporting quantity. The UE identifies at least one non-zero power (NZP) downlink reference signal resource for channel measurement based on the downlink reference signal configuration. Based on the capability, the reporting configuration, and the at least one NZP downlink reference signal resource, the UE transmits a report including a value indicating the reporting quantity.

### TECHNICAL FIELD

The present disclosure relates to wireless communications, and more specifically to reciprocity-based resource selection and reporting.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies, including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to transmit a capability message indicating a capability of the UE to support at least a partial downlink-uplink (DL-UL) reciprocity, receive, based on the capability, a reporting configuration indicating a downlink reference signal configuration and a reporting quantity, identify at least one non-zero power (NZP) downlink reference signal resource for channel measurement based on the downlink reference signal configuration, and transmit a report including a value indicating the reporting quantity based on the capability, the reporting configuration, and the at least one NZP downlink reference signal resource.

A processor (e.g., a standalone processor chipset, or a component of a UE) for wireless communication is described. The processor may be configured to, capable of, or operable to perform one or more operations as described herein. For example, the processor may be configured to, capable of, or operable to transmit a capability message indicating a capability of the UE to support at least a partial DL-UL reciprocity, receive, based on the capability, a reporting configuration indicating a downlink reference signal configuration and a reporting quantity, identify at least one NZP downlink reference signal resource for channel measurement based on the downlink reference signal configuration, and transmit a report including a value indicating the reporting quantity based on the capability, the reporting configuration, and the at least one NZP downlink reference signal resource.

A method performed or performable by a UE for wireless communication is described. The method may include transmitting a capability message indicating a capability of the UE to support at least a partial DL-UL reciprocity, receiving, based on the capability, a reporting configuration indicating a downlink reference signal configuration and a reporting quantity, identifying at least one NZP downlink reference signal resource for channel measurement based on the downlink reference signal configuration, and transmitting a report including a value indicating the reporting quantity based on the capability, the reporting configuration, and the at least one NZP downlink reference signal resource.

In some implementations of the UE, the processor, and the method described herein, the reporting configuration further indicates an uplink configuration indicating a set of uplink resources for uplink transmissions, and the UE, the processor, and the method may further be configured to, capable of, or operable to determine the value indicating the reporting quantity based on the capability, the at least one NZP downlink reference signal resource, and the uplink configuration, where the reporting quantity indicates at least one subset of resources of the set of uplink resources that is preferred for the uplink transmissions. In some implementations, the at least one subset of resources includes at least one of a semi-statically configured resource or a configured grant uplink resource that is preferred for the uplink transmissions. In some implementations, the reporting quantity includes an indication of an uplink channel representation associated with the at least one subset of resources, where the uplink channel representation is based on the capability and the at least one NZP downlink reference signal resource. In some implementations, the uplink channel representation includes at least one of a preferred uplink precoder matrix from an uplink precoder codebook or a representation of an uplink channel spatial covariance matrix.

In some implementations of the UE, the processor, and the method described herein, the UE, the processor, and the method may further be configured to, capable of, or operable to receive an indication of a sounding reference signal (SRS) configuration, determine, based on the capability and the at least one NZP downlink reference signal resource, an uplink precoder matrix associated with the at least one subset of resources, and transmit at least one SRS on an SRS resource associated with the SRS configuration, where the at least one SRS is precoded based on the uplink precoder matrix. In some implementations, the UE, the processor, and the method may further be configured to, capable of, or operable to receive an uplink scheduling message indicating the at least one subset of resources and the indication of the SRS resource corresponding to the at least one precoded SRS, precode uplink data based on the uplink precoder matrix, and transmit the precoded uplink data on the at least one subset of resources.

In some implementations of the UE, the processor, and the method described herein, the UE, the processor, and the method may further be configured to, capable of, or operable to infer at least a portion of an uplink channel over which an uplink symbol on an uplink antenna port is conveyed based on at least a portion of a downlink channel over which a downlink symbol on a downlink antenna port is conveyed. In some implementations, a phase difference between the portion of the uplink channel and the portion of the downlink channel is a constant offset within a time window. In some implementations, a relative phase difference of the portion of the uplink channel between any two uplink antenna ports compared to a relative phase difference of the portion of the downlink channel between any two downlink antenna ports is below a threshold of a maximum allowable difference of relative phase error within a time window from a last received NZP downlink reference signal resource. In some implementations, a relative power difference of the portion of the uplink channel between any two uplink antenna ports compared to a relative power difference of the portion of the downlink channel between any two downlink antenna ports is below a threshold of a maximum allowable difference of relative power error within a time window from a last received NZP downlink reference signal resource.

In some implementations of the UE, the processor, and the method described herein, the partial DL-UL reciprocity includes a reciprocity calibration for a set of multiple antenna ports or a subset of the set of multiple antenna ports. In some implementations, the reporting configuration further includes an indication of an interference measurement resource configuration, and the UE, the processor, and the method may further be configured to, capable of, or operable to determine, based on the capability, the at least one NZP downlink reference signal resource, and the interference measurement resource configuration, the value indicating the reporting quantity. In some implementations, the reporting configuration includes an indication to generate and transmit the report periodically or semi-persistently with a configured periodicity.

In some implementations of the UE, the processor, and the method described herein, the UE, the processor, and the method may further be configured to, capable of, or operable to receive an indication that activates the reporting configuration, and initiate generation and transmission of the report based on the activation of the reporting configuration. In some implementations, the UE, the processor, and the method may further be configured to, capable of, or operable to receive an indication that deactivates the reporting configuration, and stop generation and transmission of the report based on the deactivation of the reporting configuration. In some implementations, the UE, the processor, and the method may further be configured to, capable of, or operable to initiate generation and transmission of the report based on a trigger condition failing to satisfy a threshold, where the trigger condition includes a downlink radio link quality associated with an NZP downlink reference signal.

An NE (e.g., a base station, a gNB) for wireless communication is described. The NE may be configured to, capable of, or operable to perform one or more operations as described herein. For example, the NE may be configured to, capable of, or operable to receive a capability message indicating a capability of a UE to support at least a partial DL-UL reciprocity, transmit, based on the capability, a reporting configuration indicating a downlink reference signal configuration and a reporting quantity, the downlink reference signal configuration indicating at least one NZP downlink reference signal resource for channel measurement, and receive a report including a value indicating the reporting quantity based on the capability, the reporting configuration, and the at least one NZP downlink reference signal resource.

A processor (e.g., a standalone processor chipset, or a component of an NE) for wireless communication is described. The processor may be configured to, capable of, or operable to perform one or more operations as described herein. For example, the processor may be configured to, capable of, or operable to receive a capability message indicating a capability of a UE to support at least a partial DL-UL reciprocity, transmit, based on the capability, a reporting configuration indicating a downlink reference signal configuration and a reporting quantity, the downlink reference signal configuration indicating at least one NZP downlink reference signal resource for channel measurement, and receive a report including a value indicating the reporting quantity based on the capability, the reporting configuration, and the at least one NZP downlink reference signal resource.

A method performed or performable by an NE (e.g., a base station, a gNB) for wireless communication is described. The method may include receiving a capability message indicating a capability of a UE to support at least a partial DL-UL reciprocity, transmitting, based on the capability, a reporting configuration indicating a downlink reference signal configuration and a reporting quantity, the downlink reference signal configuration indicating at least one NZP downlink reference signal resource for channel measurement, and receiving a report including a value indicating the reporting quantity based on the capability, the reporting configuration, and the at least one NZP downlink reference signal resource.

In some implementations of the NE, the processor, and the method described herein, the reporting configuration further indicates an uplink configuration indicating a set of uplink resources for uplink transmissions, where the value indicating the reporting quantity is based on the capability, the at least one NZP downlink reference signal resource, and the uplink configuration, and where the reporting quantity indicates at least one subset of resources of the set of uplink resources that is preferred for the uplink transmissions. In some implementations, the at least one subset of resources includes at least one of a semi-statically configured resource or a configured grant uplink resource that is preferred for the uplink transmissions. In some implementations, the reporting quantity includes an indication of an uplink channel representation associated with the at least one subset of resources, where the uplink channel representation is based on the capability and the at least one NZP downlink reference signal resource. In some implementations, the uplink channel representation includes at least one of a preferred uplink precoder matrix from an uplink precoder codebook or a representation of an uplink channel spatial covariance matrix.

In some implementations of the NE, the processor, and the method described herein, the NE, the processor, and the method may further be configured to, capable of, or operable to transmit an indication of an SRS configuration, and receive at least one SRS on an SRS resource associated with the SRS configuration, where the at least one SRS is precoded based on an uplink precoder matrix associated with the at least one subset of resources, the uplink precoder matrix based on the capability and the at least one NZP downlink reference signal resource. In some implementations, the NE, the processor, and the method may further be configured to, capable of, or operable to transmit an uplink scheduling message indicating the at least one subset of resources and the indication of the SRS resource corresponding to the at least one precoded SRS, and receive uplink data on the at least one subset of resources, where the uplink data is precoded based on the uplink precoder matrix.

In some implementations of the NE, the processor, and the method described herein, at least a portion of an uplink channel over which an uplink symbol on an uplink antenna port is conveyed is inferable based on at least a portion of a downlink channel over which a downlink symbol on a downlink antenna port is conveyed. In some implementations, a phase difference between the portion of the uplink channel and the portion of the downlink channel is a constant offset within a time window. In some implementations, a relative phase difference of the portion of the uplink channel between any two uplink antenna ports compared to a relative phase difference of the portion of the downlink channel between any two downlink antenna ports is below a threshold of a maximum allowable difference of relative phase error within a time window from a last received NZP downlink reference signal resource. In some implementations, a relative power difference of the portion of the uplink channel between any two uplink antenna ports compared to a relative power difference of the portion of the downlink channel between any two downlink antenna ports is below a threshold of a maximum allowable difference of relative power error within a time window from a last received NZP downlink reference signal resource.

In some implementations of the NE, the processor, and the method described herein, the partial DL-UL reciprocity includes a reciprocity calibration for a set of multiple antenna ports or a subset of the set of multiple antenna ports. In some implementations, the reporting configuration further includes an indication of an interference measurement resource configuration, and the value indicating the reporting quantity is based on the capability, the at least one NZP downlink reference signal resource, and the interference measurement resource configuration. In some implementations, the reporting configuration includes an indication to generate and transmit the report periodically or semi-persistently with a configured periodicity.

In some implementations of the NE, the processor, and the method described herein, the NE, the processor, and the method may further be configured to, capable of, or operable to transmit an indication that activates the reporting configuration, where the activation of the reporting configuration initiates generation and transmission of the report. In some implementations, the NE, the processor, and the method may further be configured to, capable of, or operable to transmit an indication that deactivates the reporting configuration, where the deactivation of the reporting configuration stops generation and transmission of the report. In some implementations, the report is received based on a trigger condition failing to satisfy a threshold, where the trigger condition includes a downlink radio link quality associated with an NZP downlink reference signal.

### BRIEF DESCRIPTION OF THE DRAWINGS

FIG. 1 illustrates an example of a wireless communications system in accordance with aspects of the present disclosure.

FIG. 2 illustrates an example of a channel state information (CSI) reporting scheme in accordance with aspects of the present disclosure.

FIGS. 3 and 4 illustrate examples of information elements (IEs) in accordance with aspects of the present disclosure.

FIG. 5 illustrates an example of reciprocity-based resource selection and reporting scheme in accordance with aspects of the present disclosure.

FIG. 6 illustrates an example of a signaling diagram in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In a wireless communications system, a UE and an NE (e.g., a base station, a gNB) may support transmission and reception of signaling, referred to as wireless communication. For example, the NE may transmit downlink reference signals, such as CSI reference signals (CSI-RSs), to enable the UE to perform channel measurements and report CSI back to the NE. The NE may use the reported CSI to configure uplink transmissions from the UE, including determining appropriate precoding matrices and resource allocations. In some wireless communications systems, such as time division duplex (TDD) systems, downlink and uplink channels may exhibit reciprocity, meaning that channel characteristics measured on the downlink may be used to infer channel characteristics on the uplink.

In some wireless communication systems, uplink transmission performance depends on the availability of accurate knowledge regarding uplink channel conditions. While downlink CSI acquisition is well supported through downlink reference signals such as CSI-RS and synchronization signals, the acquisition and reporting of uplink-relevant channel information often requires additional uplink SRS transmissions. Such SRS transmissions consume uplink resources, increase signaling overhead, and may fail to scale efficiently for scenarios with dense antenna configurations or frequent channel variation. Uplink coverage constraints may also exist in some deployments. For example, higher frequency bands (FR3 7-15 GHZ) being considered for next generation (e.g., 6G) wireless networks may present challenges. Cell-edge UEs with limited transmit power may experience insufficient SRS coverage, and restrictions on SRS transmission bandwidth may negatively impact timely and accurate uplink channel knowledge. These limitations reduce the effectiveness of uplink scheduling, including resource allocation, precoding, and link adaptation.

In TDD systems, DL-UL reciprocity may exist, primarily at the base station. However, practical UE implementations may exhibit imperfect reciprocity due to radio frequency (RF) chain mismatches, calibration errors, and time-varying impairments. As a result, existing mechanisms do not sufficiently exploit partial or imperfect reciprocity at the UE, and the UE may fail to effectively infer uplink channel characteristics or uplink-relevant information from downlink measurements. Existing procedures implicitly treat reciprocity as either unavailable or as a base-station-centric calibration concern. UE-side reciprocity awareness remains outside the scope of CSI reporting, and as a result, the UE may not systematically reuse downlink measurements such as NZP CSI-RSs to infer uplink channel characteristics for resource selection or precoding decisions. Current CSI reporting mechanisms may be primarily designed to support downlink link adaptation and scheduling decisions, with limited support for conveying uplink-specific preferences or recommendations. In particular, there is no efficient mechanism for a UE to report preferred uplink resources, antenna port subsets, or uplink precoding information derived from downlink measurements under reciprocity assumptions.

This limitation reduces the ability of the base station to optimally configure uplink transmissions. Affected transmissions include physical uplink control channel (PUCCH), configured-grant resources, and precoded SRS or data transmissions. Without flexible reporting based on uplink channel conditions, uplink signaling may be either excessive or insufficiently responsive. This leads to inefficiencies in resource utilization and degraded uplink performance. Accordingly, there is a need for improved techniques that enable a UE to indicate and exploit at least partial DL-UL reciprocity capability. Such techniques may allow the UE to derive uplink-relevant channel information from downlink reference signals and report preferred uplink resources and associated channel representations in a flexible and efficient manner. Additionally, such techniques may minimize additional uplink SRS overhead, support dynamic activation and triggering, and offer benefits for uplink coverage constraint scenarios, thereby improving uplink resource utilization, transmission efficiency, and overall system performance. Accordingly, there is a need for improved techniques that enable a UE to indicate and exploit at least partial DL-UL reciprocity capability.

Aspects of the present disclosure may be described in the context of a wireless communications system, and include implementations that provide reciprocity-based resource selection and reporting. For example, a UE may transmit a capability message indicating a capability of the UE to support at least a partial DL-UL reciprocity. As used herein, DL-UL reciprocity refers to the ability to infer characteristics of an uplink channel based on measurements of a corresponding downlink channel, and partial DL-UL reciprocity indicates that this inference may be subject to certain constraints, such as calibration limitations or time-varying impairments. Based on the capability, the NE may conditionally configure uplink reporting for the UE. The UE may receive, based on the capability, a reporting configuration indicating a downlink reference signal configuration and a reporting quantity. The downlink reference signal configuration may specify parameters for downlink reference signals that the UE uses for channel measurement. The reporting quantity may indicate the type of information the UE is to report. In some implementations, the UE may identify at least one NZP downlink reference signal resource for channel measurement based on the downlink reference signal configuration. An NZP downlink reference signal resource may refer to a resource on which the NE transmits at least one reference signal with NZP, enabling the UE to measure channel characteristics. In some implementations, the identification of the at least one NZP downlink reference signal resource by the UE includes the UE receiving the at least one NZP reference signal associated with the at least one NZP downlink reference signal resource. Using the partial DL-UL reciprocity capability, the UE derives uplink-relevant channel information from these downlink measurements.

The UE may determine one or more preferred uplink resource subsets based on the derived uplink channel information. Such preferred resources may include physical resource blocks (PRBs), PUCCH resources, or configured grant uplink resources. The UE may transmit a report comprising a value indicating the reporting quantity based on the capability, the reporting configuration, and the at least one NZP downlink reference signal resource. The report may enable the NE to schedule uplink transmissions more efficiently without relying solely on uplink SRSs. In some examples, the reporting quantity may include an uplink channel representation-including one or more of a preferred uplink precoder matrix from an uplink precoder codebook, an antenna port subset indication, or a representation of an uplink channel spatial covariance matrix. The uplink channel representation may be based on the capability and the at least one NZP downlink reference signal resource. Including this information in the report enables improved uplink precoding, link adaptation, and scheduling accuracy while reducing uplink signaling overhead. In some implementations, the UE may determine a preferred uplink precoder matrix from downlink reference signal measurements and transmit SRS that may be precoded using the determined uplink precoder matrix. Subsequent uplink data transmissions may reuse spatial filters derived from the downlink measurements via spatial relation information or joint DL/UL transmission configuration indicator (TCI) states. This approach enables spatially consistent uplink transmission while accounting for imperfect reciprocity and calibration constraints.

By performing the described techniques, devices (e.g., a UE and an NE) in a wireless communications system may provide for improved uplink transmission efficiency, reduced signaling overhead, and more efficient use of resources. For example, the use of partial DL-UL reciprocity capability signaling may enable the UE to derive uplink-relevant channel information from downlink reference signal measurements, thereby reducing or eliminating the need for additional uplink SRS transmissions. This may enable improved uplink coverage, particularly in scenarios involving cell-edge UEs with limited transmit power or higher frequency bands with constrained link budgets. Additionally, the reporting of preferred uplink resources and uplink channel representations based on downlink measurements may enable the NE to perform more accurate uplink scheduling, precoding, and link adaptation without relying solely on uplink sounding. The UE may identify preferred uplink resource subsets, determine uplink precoder matrices from downlink channel estimates, and report this information to the NE via the configured reporting mechanism. The use of different reporting configurations (e.g., periodic, semi-persistent, or aperiodic) and activation and deactivation mechanisms may enable optimization for different deployment scenarios and channel conditions, with dynamic triggering based on downlink radio link quality enabling conditional reporting and responsive adaptation to changing channel conditions while minimizing unnecessary reporting overhead.

Reference is made herein to communicating data or information, such as signaling communication resources and/or communications that may be transmitted or received between devices. It is to be appreciated that other terms may be used interchangeably with communicating, such as signaling, transmitting, receiving, outputting, forwarding, retrieving, obtaining, and so forth.

Aspects of the present disclosure may be described in the context of a wireless communications system. Aspects of the present disclosure may be further set forth in the accompanying drawings and the description below. The description set forth herein, in connection with the accompanying drawings, describes example implementations and does not represent all the implementations that may be implemented or that may be within the scope of the claims. The detailed description includes specific details for the purpose of providing an understanding of the described implementations. These implementations, however, may be practiced without these specific details. Additionally, the description set forth herein, in connection with the accompanying drawings, is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

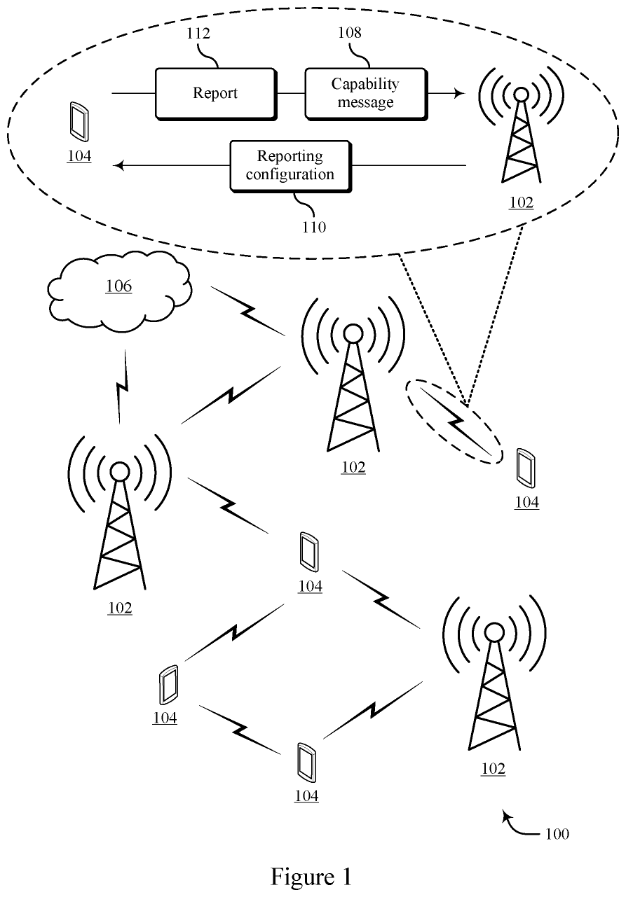

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation (e.g., 5G) NodeB (gNB), a 6G NodeB (aNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., Orthogonal Frequency Division Multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 may be operable to implement various aspects of the techniques described with reference to the present disclosure. For example, a UE 104 may transmit a capability message 108 indicating a capability of the UE 104 to support at least a partial DL-UL reciprocity. Based on the capability, the NE 102 may conditionally configure uplink reporting for the UE 104. The UE may receive, based on the capability, a reporting configuration 110 indicating a downlink reference signal configuration and a reporting quantity. The downlink reference signal configuration may specify parameters for downlink reference signals that the UE 104 uses for channel measurement, and the reporting quantity may indicate the type of information the UE 104 is to report. In some implementations, the UE 104 may identify at least one NZP downlink reference signal resource for channel measurement based on the downlink reference signal configuration. Using the partial DL-UL reciprocity capability, the UE 104 may derive uplink-relevant channel information from such downlink measurements. The UE 104 may transmit a report 112 including a value indicating the reporting quantity based on the capability, the reporting configuration 110, and the at least one NZP downlink reference signal resource. The report may enable the NE 102 to schedule uplink transmissions more efficiently without relying solely on uplink SRSs.

By enabling UE-assisted uplink resource selection and precoding based on at least partial DL-UL reciprocity, the described techniques enable UEs 104 to derive uplink decisions, recommendations, or preferences from downlink reference signal measurements rather than the NEs 102 relying solely on uplink sounding. Techniques enabling the UE 104 to signal at least partial DL-UL reciprocity capability via higher-layer configuration may allow the network to conditionally configure uplink reporting based on that capability. Additionally, the described techniques enable a network-configured reporting framework in which the UE 104 receives indications of uplink resources, downlink reference signal configurations, and reporting quantities tailored to UE-side reciprocity-capable operation. The techniques described herein also support deriving uplink transmission preferences by computing reporting quantities from received NZP downlink RS resources using partial DL-UL reciprocity, including identification of preferred uplink resource subsets. Additionally, the techniques described herein enable the UE 104 to determine and report preferred uplink resource subsets, including uplink PRBs, PUCCH resources, or configured-grant resources, based on reciprocity-derived channel conditions, and to infer uplink channel characteristics from downlink channel measurements under defined phase, amplitude, and power consistency thresholds. The described techniques also provide for UE-side reciprocity calibration accounting for imperfect reciprocity including RF chain mismatches and calibration errors, by defining calibration error bounds/thresholds on relative phase, amplitude, or power differences within a defined time window, and the described techniques provide operations that support reciprocity applicability to subsets or groups of antenna ports, enabling flexible support for multi-panel and multi-antenna UE 104 implementations. In addition, mechanisms are described for uplink channel representation reporting including indications of preferred uplink precoders, uplink codebook entries, antenna port subsets, or uplink channel spatial covariance information derived from downlink reference signal measurements, as well as integration of interference-aware measurements, where NZP reference signal, ZP reference signal, or other interference measurement reference signal resources (e.g., uplink resources such as uplink slots or symbols) may be used in conjunction with reciprocity to refine CSI reporting. The techniques described herein support coordination between CSI reporting and SRS transmission, enabling the UE 104 to select and apply reciprocity-derived uplink precoding for SRS and subsequent uplink data transmissions, as well as flexible activation, triggering, and periodicity control of reciprocity-based reporting via higher-layer signaling, medium access control (MAC) control element (MAC-CE), or downlink control information (DCI), including conditional reporting based on downlink quality thresholds. Additionally, the described techniques support CSI report prioritization mechanisms to manage multiple simultaneous CSI reports for uplink and downlink, accounting for UE 104 CSI processing unit constraints and report criticality, as well as mechanisms that enable the UE 104 to reuse downlink NZP reference signals (e.g., CSI-RS) to compute uplink-relevant channel information, reducing uplink SRS overhead and issues with uplink coverage (e.g., high frequency band, cell-edge) thereby improving UL scheduling, link adaptation, and uplink system performance.

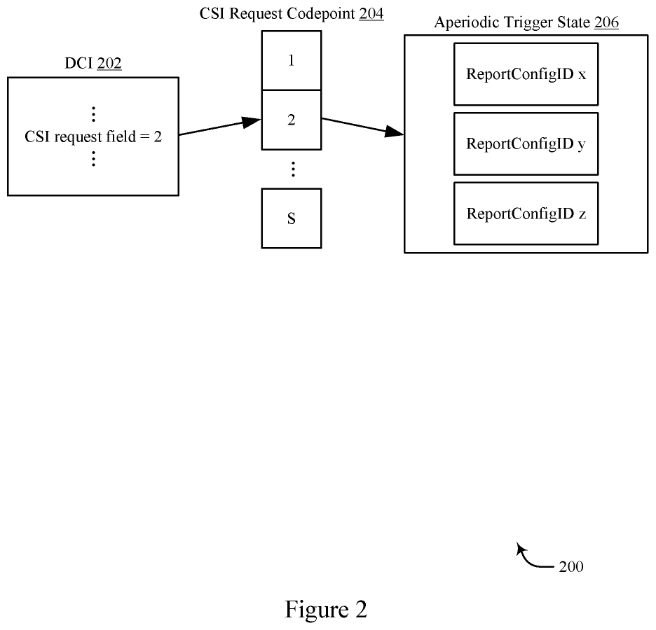

FIG. 2 illustrates an example of a CSI reporting scheme 200 in accordance with aspects of the present disclosure. In the example of FIG. 2, the CSI reporting scheme 200 may involve a DCI 202 (e.g., a DCI format 0-1) indicating a CSI request codepoint 204, and the CSI request codepoint indicating an aperiodic trigger state 206 (e.g., an aperiodic trigger state 2) that defines a list of CSI report settings, such as a ReportConfigID x, a ReportConfigID y, and a ReportConfigID z.

In an NR CSI framework, a UE may report CSI information to an NE using the CSI reporting scheme 200 (e.g., a CSI framework), which may be based on a CSI report setting and a CSI resource setting. A triggering mechanism between a report setting and a resource setting is summarized in Table 1.

TABLE 1
Triggering mechanism between a report setting and a resource setting

| | | Periodic CSI | | AP CSI |
|---|---|---|---|---|
| | | reporting | SP CSI reporting | Reporting |
| Time Domain | Periodic CSI-RS | RRC configured | MAC CE (PUCCH) | DCI |
| Behavior of | | | DCI (PUSCH) | |
| Resource | SP CSI-RS | Not Supported | MAC CE (PUCCH) | DCI |
| Setting | | | DCI (PUSCH) | |
| | AP CSI-RS | Not Supported | Not Supported | DCI |

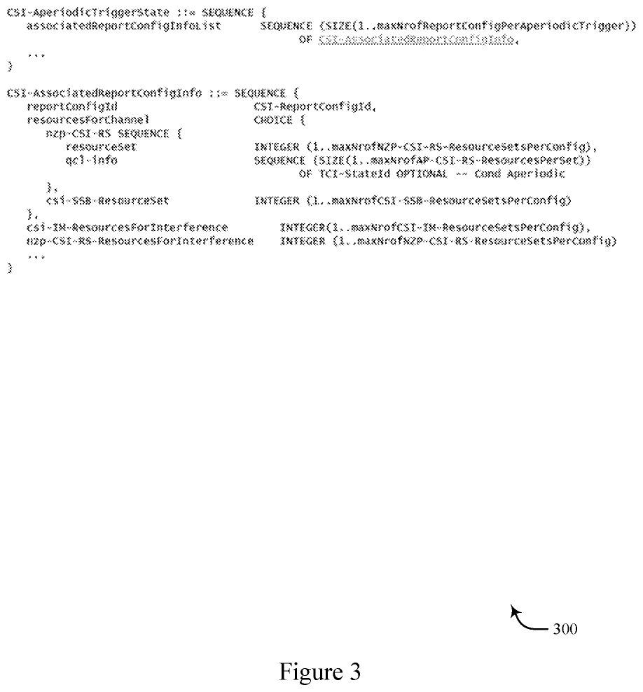

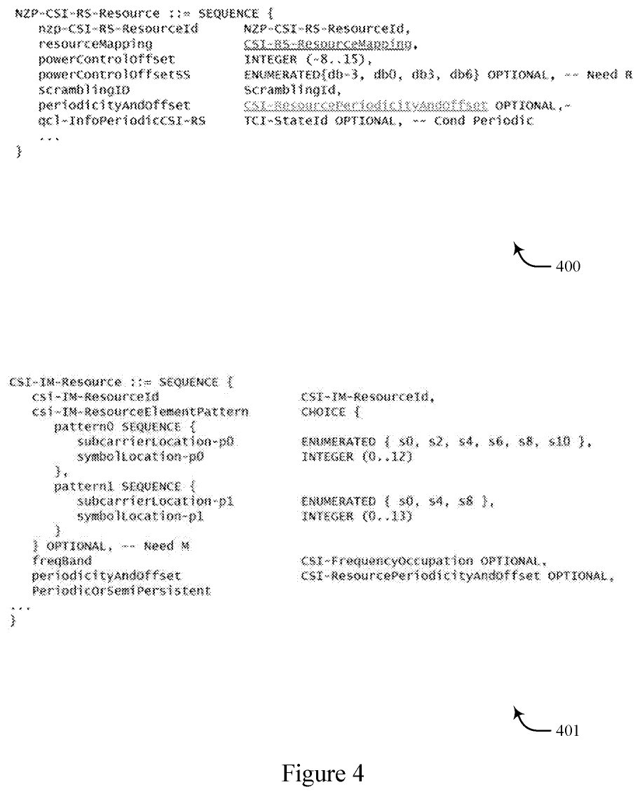

Additionally, resource settings associated with a CSI report setting may have the same time domain, and periodic CSI-RS/interference management (IM) resources and CSI reports may be assumed as present and active once configured by radio resource control (RRC) signaling, while aperiodic and semi-persistent CSI-RS IM resources and CSI reports may be explicitly triggered or activated. Additionally, aperiodic CSI-RS/IM resources and aperiodic CSI reports may be jointly triggered by the transmission of the DCI 202 (e.g., a DCI Format 0-1), while semi-persistent CSI-RS/IM resources and semi-persistent CSI reports may be independently activated. In some examples, the DCI 202 may include a 0- to 6-bit CSI request field (e.g., CSI request field=2). A non-zero CSI request field may point to the aperiodic trigger state 206, which may be configured by RRC signaling. As described herein, the aperiodic trigger state 206 may be defined as a list of up to 16 aperiodic CSI report settings, each identified by a CSI report setting identifier (ID) (e.g., ReportConfigID x, a ReportConfigID y, and a ReportConfigID z) for which the UE may simultaneously calculate CSI and transmit the CSI via a scheduled PUSCH transmission. A CSI-AperiodicTriggerState IE, an NZP-CSI-RS-Resource IE, and a CSI-IM-Resource IE utilized for configuring the aperiodic trigger state 206 and associated CSI report settings may be described herein with reference to FIGS. 3 and 4.

In NR, two transmission modes exist for precoded PUSCH transmission: codebook-based transmission and non-codebook-based transmission. For codebook-based transmission, PUSCH may be scheduled by DCI format 0_0, DCI format 0_1, DCI format 0_2 or semi-statically configured to operate. If such PUSCH is scheduled by DCI format 0_1, DCI format 0_2, or semi-statically configured to operate, a UE determines its PUSCH transmission precoder based on an SRS resource indicator (SRI), transmit precoding matrix indication (TPMI), and the transmission rank, where the SRI, TPMI, and the transmission rank may be given by DCI fields of the SRI and precoding information and number of layers for DCI format 0_1 and 0_2 or given by higher-layer parameters srs-ResourceIndicator and precodingAndNumberOfLayers for semi-static configuration. The SRS-ResourceSet(s) applicable for PUSCH scheduled by DCI format 0_1 and DCI format 0 2 may be defined by the entries of the higher-layer parameter srs-ResourceSetToAddModList and srs-ResourceSetToAddModListForDCI-Format0-2-r16 in SRS-config, respectively. The TPMI is used to indicate the precoder to be applied over the layers {0 . . . v−1} and that corresponds to the SRS resource selected by the SRI when multiple SRS resources may be configured, or if a single SRS resource is configured, TPMI is used to indicate the precoder to be applied over the layers {0 . . . v−1} and that corresponds to the SRS resource. The transmission precoder may be selected from the uplink codebook that has a number of antenna ports equal to the higher-layer parameter nrofSRS-Ports in SRS-Config. When the UE is configured with the higher-layer parameter txConfig set to ‘codebook,’ the UE is configured with at least one SRS resource. The indicated SRI in slot nis associated with the most recent transmission of SRS resource identified by the SRI, where the SRS resource is prior to the physical downlink control channel (PDCCH) carrying the SRI.

For codebook-based transmission, the UE determines its codebook subsets based on TPMI and upon the reception of the higher-layer parameter codebookSubset in pusch-Config for PUSCH associated with DCI format 0_1 and codebookSubsetForDCI-Format0-2-r16 in pusch-Config for PUSCH associated with DCI format 0_2, which may be configured with ‘fully AndPartialAndNonCoherent,’ or ‘partialAndNonCoherent,’ or ‘nonCoherent’ depending on the UE capability. When the higher-layer parameter ul-FullPowerTransmission-r16 is set to ‘fullpowerMode2’ and the higher-layer parameter codebookSubset or the higher-layer parameter codebookSubsetForDCI-Format0-2-r16 is set to ‘partialAndNonCoherent,’ and when the SRS-resourceSet with usage set to “codebook” includes at least one SRS resource with four ports and one SRS resource with two ports, the codebookSubset associated with the two-port SRS resource is ‘nonCoherent’. The maximum transmission rank may be configured by the higher-layer parameter maxRank in pusch-Config for PUSCH scheduled with DCI format 0_1 and maxRank-ForDCIFormat0_2 for PUSCH scheduled with DCI format 0_2.

A UE reporting its UE capability of ‘partialAndNonCoherent’ transmission may not expect to be configured by either codebookSubset or codebookSubsetForDCI-Format0-2-r16 with ‘fullyAndPartialAndNonCoherent.’ A UE reporting its UE capability of ‘nonCoherent’ transmission may not expect to be configured by either codebookSubset or codebookSubsetForDCI-Format0-2-r16 with ‘fully AndPartialAndNonCoherent’ or with ‘partialAndNonCoherent.’ A UE may not expect to be configured with the higher layer parameter codebookSubset or the higher layer parameter codebookSubsetForDCI-Format0-2-r16 set to ‘partialAndNonCoherent’ when higher layer parameter nrofSRS-Ports in an SRS-ResourceSet with usage set to ‘codebook’ indicates that the maximum number of the configured SRS antenna ports in the SRS-ResourceSet is two. For codebook-based transmission, the UE may be configured with a single SRS-ResourceSet with usage set to ‘codebook’ and only one SRS resource may be indicated based on the SRI from within the SRS resource set. Except when higher layer parameter ul-FullPowerTransmission-r16 is set to ‘fullpowerMode2,’ the maximum number of configured SRS resources for codebook-based transmission may be two. If aperiodic SRS is configured for a UE, the SRS request field in DCI triggers the transmission of aperiodic SRS resources.

A UE may not expect to be configured with higher layer parameter ul-FullPowerTransmission-r16 set to ‘fullpowerMode1’ and codebookSubset or codebookSubsetForDCI-Format0-2-r16 set to ‘fullAndPartialAndNonCoherent’ simultaneously. The UE may transmit PUSCH using the same antenna port(s) as the SRS port(s) in the SRS resource indicated by the DCI format 0_1 or 0_2 or by configuredGrantConfig. The demodulation reference signal (DMRS) antenna ports {\tilde{p}₀, . . . , \tilde{p}ᵥ₋₁} may be determined according to the ordering of DMRS port(s) indicated in the DCI. Except when higher layer parameter ul-FullPower Transmission-r16 is set to ‘fullpowerMode2’ when multiple SRS resources may be configured by SRS-ResourceSet with usage set to ‘codebook,’ the UE may expect that higher layer parameters nrofSRS-Ports in SRS-Resource in SRS-ResourceSet may be configured with a same value for all these SRS resources.

When higher layer parameter ul-FullPowerTransmission-r16 is set to ‘fullpowerMode2,’ the UE may be configured with one SRS resource or multiple SRS resources with same or different number of SRS ports within an SRS resource set with usage set to ‘codebook.’ Up to 2 different spatial relations may be configured for all SRS resources in the SRS resource set with usage set to ‘codebook’ when multiple SRS resources may be configured in the SRS resource set. Subject to UE capability, a maximum of two or four SRS resources may be supported in an SRS resource set with usage set to ‘codebook.’

In some examples, a block of vectors

$${[ {y}^{( 0 )} ( i ) … {y}^{( v - 1 )} ( i ) ]}^{T} , i = 0 , 1 , … , {M}_{s y m b}^{layer} - 1$$

may be precoded according to

$$[ \begin{matrix}{z}^{( {p}_{0} )} ( i ) \\ ⋮ \\ {z}^{( {p}_{ρ - 1} )} ( i )\end{matrix} ] = W [ \begin{matrix}{y}^{( 0 )} ( i ) \\ ⋮ \\ {y}^{( v - 1 )} ( i )\end{matrix} ] where$$

$$i = 0 , 1 , … , {M}_{symb}^{ap} - 1 , and {M}_{symb}^{ap} = {M}_{symb}^{layer} .$$

The set of antenna ports {p₀, . . . , p_{ρ-1}} may be determined according to various procedures. For non-codebook-based transmission, the precoding matrix W equals the identity matrix. For codebook-based transmission, the precoding matrix W is given by W=1 for single-layer transmission on a single antenna port, otherwise by Tables 2 through 8 with the TPMI index obtained from the DCI scheduling the uplink transmission or the higher layer parameters for semi-static scheduling or configured grant. When the higher-layer parameter txConfig is not configured, the precoding matrix W=1.

TABLE 2
Precoding matrix W for single-layer transmission using two antenna ports.

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 3
Precoding matrix W for single-layer transmission using four antenna
ports with transform precoding enabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 4
Precoding matrix W for single-layer transmission using four antenna
ports with transform precoding disabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 5
Precoding matrix W for two-layer transmission using two antenna ports
with transform precoding disabled.

| TPMI | W | | |
|---|---|---|---|
| index | (ordered from left to right in increasing order of TPMI index) | | |
| 0-2 | $\frac{1}{2} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 6
Precoding matrix W for two-layer transmission using four antenna ports
with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 7
Precoding matrix W for three-layer transmission using four antenna ports
with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4 - 6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 8
Precoding matrix W for four-layer transmission using four antenna ports
with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

The UE may be configured with one or more SRS resource sets as configured by the higher layer parameter SRS-ResourceSet, wherein each SRS resource set is associated with K≥1 SRS resources (higher layer parameter SRS-Resource), where the maximum value of K is indicated by UE capability. The SRS resource set applicability is configured by the higher layer parameter usage in SRS-ResourceSet. The higher-layer parameter SRS-Resource configures some SRS parameters, including the SRS resource configuration identity (e.g., srs-ResourceId), the number of SRS ports (e.g., nrofSRS-Ports) with a default value of one, and the time-domain behaviour of SRS resource configuration (e.g., resourceType).

The UE may be configured by the higher layer parameter resourceMapping in SRS-Resource with an SRS resource occupying Nₛ∈{1,2,4} adjacent symbols within the last six symbols of the slot, where all antenna ports of the SRS resources may be mapped to each symbol of the resource. For a UE configured with one or more SRS resource configuration(s), and when the higher layer parameter resourceType in SRS-Resource is set to ‘aperiodic,’ the UE receives a configuration of SRS resource sets. Additionally, the UE receives a downlink DCI, a group common DCI, or an uplink DCI-based command where a codepoint of the DCI may trigger one or more SRS resource set(s). For SRS in a resource set with usage set to ‘codebook’ or ‘antennaSwitching,’ the minimal time interval between the last symbol of the PDCCH triggering the aperiodic SRS transmission and the first symbol of SRS resource is N₂. Otherwise, the minimal time interval between the last symbol of the PDCCH triggering the aperiodic SRS transmission and the first symbol of SRS resource is N₂+14. The minimal time interval in units of OFDM symbols is counted based on the minimum subcarrier spacing between the PDCCH and the aperiodic SRS. Additionally, if the UE is configured with the higher layer parameter spatialRelationInfo containing the ID of a reference ‘ssb-Index,’ the UE may transmit the target SRS resource with the same spatial domain transmission filter used for the reception of the reference synchronization signal block (SSB)/physical broadcast channel (PBCH) block, if the higher layer parameter spatialRelationInfo contains the ID of a reference ‘csi-RS-Index,’ the UE may transmit the target SRS resource with the same spatial domain transmission filter used for the reception of the reference periodic CSI-RS or of the reference semi-persistent CSI-RS, or of the latest reference aperiodic CSI-RS. If the higher layer parameter spatialRelationInfo contains the ID of a reference ‘srs,’ the UE may transmit the target SRS resource with the same spatial domain transmission filter used for the transmission of the reference periodic SRS or of the reference semi-persistent SRS or of the reference aperiodic SRS. Additionally, the spatial relation update command contains spatial relation assumptions provided by a list of references to reference signal IDs, one per element of the updated SRS resource set. Each ID in the list refers to a reference SS/PBCH block, NZP CSI-RS resource configured on serving cell indicated by Resource Serving Cell ID field in the update command if present, same serving cell as the SRS resource set otherwise, or SRS resource configured on serving cell and uplink bandwidth part (BWP) indicated by Resource Serving Cell ID field and Resource BWP ID field in the update command if present, same serving cell and bandwidth part as the SRS resource set otherwise. When the UE is configured with the higher layer parameter usage in SRS-ResourceSet set to ‘antennaSwitching,’ the UE may not expect to be configured with different spatial relations for SRS resources in the same SRS resource set.

For PUCCH and SRS on the same carrier, a UE may refrain from transmitting SRS when semi-persistent and periodic SRS may be configured in the same symbol(s) with PUCCH carrying only CSI report(s), or only layer 1 (L1) reference signal received power (RSRP) report(s), or only L1-signal interference-to-noise-ratio (SINR) report(s). A UE may refrain from transmitting SRS when semi-persistent or periodic SRS is configured or aperiodic SRS is triggered to be transmitted in the same symbol(s) with PUCCH carrying hybrid automatic repeat request acknowledgment (HARQ-ACK), link recovery request and/or scheduling request. In the case that SRS is not transmitted due to overlap with PUCCH, only the SRS symbol(s) that overlap with PUCCH symbol(s) may be dropped. The UE may refrain from transmitting PUCCH when aperiodic SRS is triggered to be transmitted to overlap in the same symbol with PUCCH carrying semi-persistent/periodic CSI report(s) or semi-persistent/periodic L1-RSRP report(s) only, or only L1-SINR report(s). When the UE is configured with the higher layer parameter usage in SRS-ResourceSet set to ‘antennaSwitching,’ and a guard period of Y symbols is configured, the UE may use the same priority rules as defined above during the guard period as if SRS was configured.

When the UE is configured with the higher-layer parameter usage in SRS-ResourceSet set as ‘antennaSwitching,’ the UE may be configured with one configuration depending on the indicated UE capability supported SRS-TxPortSwitch, which takes on the values {‘t1r2,’ ‘t1r1−t1r2,’ ‘t2r4,’ ‘t1r4,’ ‘t1r1−t1r2−t1r4,’ ‘t1r4−t2r4,’ ‘t1r1−t1r2−t2r2−t2r4,’ ‘t1r1−t1r2−t2r2−t1r4−t2r4,’ ‘t1r1,’ ‘t2r2,’ ‘t1r1−t2r2,’ ‘t4r4,’ ‘t1r1−t2r2−t4r4’}. For 1T2R, up to two SRS resource sets configured with a different value for the higher layer parameter resourceType in SRS-ResourceSet set, where each set has two SRS resources transmitted in different symbols, each SRS resource in a given set consisting of a single SRS port, and the SRS port of the second resource in the set is associated with a different UE antenna port than the SRS port of the first resource in the same set. For 2T4R, up to two SRS resource sets configured with a different value for the higher layer parameter resource Type in SRS-Resource Set set, where each SRS resource set has two SRS resources transmitted in different symbols, each SRS resource in a given set consisting of two SRS ports, and the SRS port pair of the second resource is associated with a different UE antenna port pair than the SRS port pair of the first resource. For 1T4R, zero or one SRS resource set configured with higher layer parameter resource Type in SRS-ResourceSet set to ‘periodic’ or ‘semi-persistent’ with four SRS resources transmitted in different symbols, each SRS resource in a given set consisting of a single SRS port, and the SRS port of each resource is associated with a different UE antenna port. For 1T4R, zero or two SRS resource sets each configured with higher layer parameter resource Type in SRS-ResourceSet set to ‘aperiodic’ and with a total of four SRS resources transmitted in different symbols of two different slots, and where the SRS port of each SRS resource in the given two sets is associated with a different UE antenna port. The two sets may each be configured with two SRS resources, or one set is configured with one SRS resource and the other set is configured with three SRS resources. For 1T=1R, or 2T=2R, or 4T=4R, up to two SRS resource sets each with one SRS resource, where the number of SRS ports for each resource is equal to 1, 2, or 4.

The UE is configured with a guard period of Y symbols, in which the UE does not transmit any other signal, in the case the SRS resources of a set may be transmitted in the same slot. The guard period is in-between the SRS resources of the set. The value of Y is 2 when the OFDM sub-carrier spacing is 120 kHz, otherwise Y=1. For 1T2R, 1T4R or 2T4R, the UE may not expect to be configured or triggered with more than one SRS resource set with higher layer parameter usage set as ‘antennaSwitching’ in the same slot. For 1T=1R, 2T=2R or 4T=4R, the UE may not expect to be configured or triggered with more than one SRS resource set with higher layer parameter usage set as ‘antennaSwitching’ in the same symbol.

In some examples, the terms antenna, panel, and antenna panel may be used interchangeably to refer to the same component. An antenna panel may be hardware that is used for transmitting and/or receiving radio signals at frequencies lower than 6 GHz (e.g., frequency range 1 (FR1)), frequencies between 7 GHz and 15 GHz (e.g., frequency range 3 (FR3)), or higher than 24 GHz, (e.g., frequency range 2 (FR2) or millimeter wave (mmWave)). In some examples, an antenna panel may include an array of antenna elements, where each antenna element is connected to hardware such as a phase shifter that allows a control module to apply spatial parameters for transmission and/or reception of signals. The resulting radiation pattern may be referred to as a beam, which may or may not be unimodal and may allow a device (e.g., a UE, an NE, a node) to amplify signals that may be transmitted or received from spatial directions.

In some examples, an antenna panel may or may not be virtualized as an antenna port in the specifications. An antenna panel may be connected to a baseband processing module through an RF chain for each of transmission (e.g., egress, output) and reception (e.g., ingress, input) directions. A capability of a device (e.g., a UE, an NE) in terms of the number of antenna panels, their duplexing capabilities, their beamforming capabilities, and so on, may be transparent to other devices. In some examples, capability information may be communicated via signaling, or, in some examples, capability information may be provided to devices without a need for signaling. In the case that such information is available to other devices, it may be used for signaling or local decision making.

In some examples, a device (e.g., a UE, an NE, a node) antenna panel may be a physical or logical antenna array comprising a set of antenna elements or antenna ports that may be a common or a significant portion of an RF chain (e.g., in-phase/quadrature (I/Q) modulator, analog to digital (A/D) converter, local oscillator, phase shift network). The device antenna panel, referred to as a device panel, may be a logical entity with physical device antennas mapped to the logical entity. The mapping of physical device antennas to the logical entity may be up to device implementation. Communicating (e.g., receiving or transmitting) on at least a subset of antenna elements or antenna ports active for radiating energy (also referred to herein as active elements) of an antenna panel may require biasing or powering on of the RF chain, which may result in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit RF energy or to a receiver to receive RF energy, either simultaneously or sequentially, or may be coupled to a transceiver in general, for performing its intended functionality. Communicating on the active elements of an antenna panel enables generation of radiation patterns or beams.

In some examples, depending on a device's own implementation, a device panel may have at least one of the following functionalities: an operational role of unit of antenna group to control its transmit beam independently, unit of antenna group to control its transmission power independently, or unit of antenna group to control its transmission timing independently. The device panel may be transparent to the NE (e.g., a base station, a gNB). For some conditions, the NE may assume the mapping between a device's physical antennas to the logical entity device panel may not be changed. For example, the condition may include until the next update or report from the device, or include a duration of time over which the NE assumes there may be no change to the mapping. A device may report its capability with respect to the device panel to the NE. The device capability may include at least the number of device panels. In some implementations, device capability may include a number of simultaneous transmissions over multiple panels or in multiple directions (e.g., corresponding to a number of uplink TCI states or spatial relations). In some implementations, the device may support uplink transmission from one beam within a panel; with multiple panels, more than one beam (one beam per panel) may be used for uplink transmission. In another implementation, more than one beam per panel may be supported and used for uplink transmission.

In some implementations, an antenna port may be defined such that the channel over which a symbol on the antenna port is conveyed may be inferred from the channel over which another symbol on the same antenna port is conveyed. In some examples, two antenna ports may be said to be quasi co-located (QCL) if a device may infer the large-scale properties of the channel over which a symbol on one antenna port is conveyed from the channel over which a symbol on the other antenna port is conveyed. The large-scale properties include one or more of delay spread, Doppler spread, Doppler shift, average gain, average delay, and spatial receive parameters. Two antenna ports may be quasi-located with respect to a subset of the large-scale properties and a different subset of large-scale properties may be indicated by a QCL Type. The QCL Type may indicate which channel properties may be the same between the two reference signals (e.g., on the two antenna ports). Thus, the reference signals may be linked to each other with respect to what the device may assume about their channel statistics or QCL properties. For example, QCL-Type may take one of the following values: ‘QCL-TypeA’: {Doppler shift, Doppler spread, average delay, delay spread}, ‘QCL-TypeB’: {Doppler shift, Doppler spread}, ‘QCL-TypeC’: {Doppler shift, average delay}, and ‘QCL-TypeD’: {Spatial Rx parameter}. Other QCL-Types may be defined based on a combination of one or more large-scale properties (e.g., spatial non-stationarity, phase continuity, power consistency).

Spatial receive parameters may include one or more of: angle of arrival (AoA), Dominant AoA, average AoA, angular spread, Power Angular Spectrum (PAS) of AoA, average angle of departure (AoD), PAS of AoD, transmit/receive channel correlation, transmit/receive beamforming, spatial channel correlation, and so forth. The QCL-TypeA, QCL-TypeB, and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, (i.e., the UE would need to form beams for directional transmission). A QCL-TypeD between two reference signals A and B, the reference signal A is considered to be spatially co-located with reference signal B and the UE may assume that the reference signals A and B may be received with the same spatial filter (e.g., with the same receive beamforming weights).

According to some implementations, an antenna port may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a TCI state associated with a target transmission may indicate parameters for configuring a QCL relationship between a target transmission (e.g., target reference signal of DMRS ports of the target transmission during a transmission occasion) and a source reference signal(s) (e.g., SSB/CSI-RS/SRS) with respect to QCL type parameter(s) indicated in the corresponding TCI state. The TCI describes which reference signals may be used as QCL source, and what QCL properties may be derived from each reference signal. A device may receive a configuration of a set of multiple TCI states for a serving cell for transmissions on the serving cell. In some of the implementations described, a TCI state may include at least one source reference signal to provide a reference (a UE assumption) for determining a QCL and/or a spatial filter.

In some implementations, a spatial relation information associated with a target transmission may indicate parameters for configuring a spatial setting between the target transmission and a reference signal (e.g., SSB/CSI-RS/SRS). For example, the device may transmit the target transmission with the same spatial domain filter used for reception of the reference signal (e.g., downlink RS such as SSB/CSI-RS). In another example, the device may transmit the target transmission with the same spatial domain transmission filter used for the transmission of the reference signal (e.g., uplink RS such as SRS). A device may receive a configuration of a plurality of spatial relation information configurations for a serving cell for transmissions on the serving cell.

In some examples, an uplink TCI state may be provided if a device is configured with separate downlink/uplink TCI by RRC signaling. The uplink TCI state may include a source reference signal which provides a reference for determining uplink spatial domain transmission filter for the uplink transmission (e.g., dynamic grant/configured grant based PUSCH, dedicated PUCCH resources) in a component carrier or across a set of configured component carriers/BWPs. In some implementations, a joint downlink/uplink TCI state may be provided if the device is configured with joint downlink/uplink TCI by RRC signaling (e.g., configuration of joint TCI or separate downlink/uplink TCI is based on RRC signaling). The joint downlink/uplink TCI state refers to at least a common source reference signal used for determining both the downlink QCL information and the uplink spatial transmission filter. The source reference signal determined from the indicated joint (or common) TCI state provides QCL Type-D indication (e.g., for device-dedicated PDCCH/PDSCH) and is used to determine uplink spatial transmission filter (e.g., for UE-dedicated PUSCH/PUCCH) for a component carrier or across a set of configured component carriers/BWPs. In one example, the uplink spatial transmission filter is derived from the reference signal of downlink QCL Type D in the joint TCI state. The spatial setting of the uplink transmission may be according to the spatial relation with a reference to the source reference signal configured with qcl-Type set to ‘typeD’ (e.g., QCL Type D) in the joint TCI state. In some of the examples described, a device may be provided with more than one spatial relations or uplink TCI states, and transmit a number of simultaneous transmissions in multiple directions corresponding to the provided more than one spatial relations or uplink TCI states, e.g., via multiple panels.

FIG. 3 illustrates an example of a CSI-AperiodicTriggerState IE 300 in accordance with aspects of the present disclosure. In some examples, the CSI-AperiodicTriggerState IE 300 implements or is implemented by aspects of the wireless communications system 100 and the CSI reporting scheme 200. For example, when a CSI report setting is linked with an aperiodic resource setting (which may include multiple resource sets), an aperiodic trigger state definition in the CSI-AperiodicTriggerState IE 300 may include one or more of an aperiodic NZP CSI-RS resource set for channel measurement, an aperiodic CSI-IM resource set (if used), and an aperiodic NZP CSI-RS resource set for IM (if used) for a given CSI report setting. For aperiodic NZP CSI-RSs, the aperiodic trigger state may also configure a QCL source. In such cases, the UE may assume that resources used for the computation of the channel and interference may be processed with the same spatial filter (e.g., QCL according to QCL-TypeD).

FIG. 4 illustrates an example of an NZP-CSI-RS-Resource IE 400 and a CSI-IM-Resource IE 401 in accordance with aspects of the present disclosure. In some examples, the NZP-CSI-RS-Resource IE 400 and the CSI-IM-Resource IE 401 implement or may be implemented by aspects of the wireless communications system 100 and the CSI reporting scheme 200. For example, the NZP-CSI-RS-Resource IE 400 may include an RRC configuration for NZP-CSI-RS resources and CSI-IM-Resource IE 401 may include an RRC configuration for CSI-IM resources.

In some examples, a CSI report setting identified by a CSI report setting ID (e.g., ReportConfigID) may configure a UE to report CSI in one or more of a periodic, semi-persistent, or aperiodic manner. For periodic and semi-persistent CSI reporting, the UE may determine CSI report quantities (e.g., CSI-RS resource indicator (CRI), L1-RSRP, L1-SINR) in a periodic manner. An NE may trigger aperiodic CSI reporting based on a network-monitored event (e.g., based on HARQ-ACK feedback), and the NE may trigger a new CSI feedback report whenever the NE receives a negative ACK (NACK) or at the start of a scheduling burst. In some examples, the UE may support UE-initiated CSI (e.g., beam measurement) reporting, where the NE may configure the UE with a triggering event. When the triggering event is satisfied, the UE may report an indication flag of event-triggered beam measurement reporting in a first stage of a CSI report, and further beam/channel measurement values in a second stage of the CSI report. The presence of the second stage of the CSI report may be conditioned on the UE reporting the value of the indication flag of event-triggered beam measurement reporting in the first stage of the CSI report.

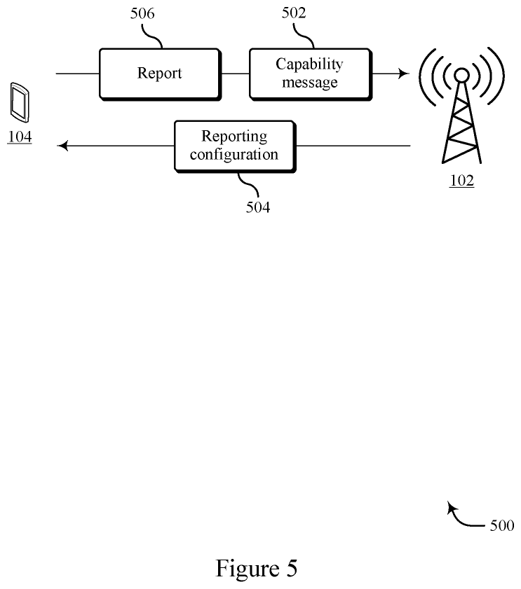

FIG. 5 illustrates an example of reciprocity-based resource selection and reporting scheme 500 in accordance with aspects of the present disclosure. In some examples, the reciprocity-based resource selection and reporting scheme 500 implements or is implemented by aspects of the wireless communications system 100, the CSI reporting scheme 200, the CSI-AperiodicTriggerState IE 300, the NZP-CSI-RS-Resource IE 400, and the CSI-IM-Resource IE 401. For example, the reciprocity-based resource selection and reporting scheme 500 may implement or be implemented by an NE 102 and a UE 104, which may be examples of the corresponding devices as described with reference to FIGS. 1 through 4. Different implementation examples may be provided in the following description, and the occurrence of a combination of one or more implementation examples may also be considered. Although some of the examples may be described in terms of a UE 104 or an NE 102 (e.g., a node, a base station, a gNB) receiving data (e.g., via downlink or uplink), the methods described here may also be applicable for a UE 104 or an NE 102 transmitting data (e.g., via uplink or downlink). Additionally, references herein to DMRSs may also be applicable to other reference signals, such as CSI-RSs, SRSs or a combination of various types of reference signals.

As described herein, the UE 104 may transmit a capability message 502 (e.g., a capability configuration message) indicating a capability of the UE 104 to support at least a partial DL-UL reciprocity. In some examples, the capability message 502 may include a higher-layer parameter indicative of the partial DL-UL reciprocity capability of the UE 104. Based on the capability, the NE 102 may configure uplink reporting for the UE 104. The UE may receive, based on the capability, a reporting configuration 504 (e.g., a CSI reporting configuration) indicating a downlink reference signal configuration and a reporting quantity. The downlink reference signal configuration may specify parameters for downlink reference signals that the UE 104 uses for channel measurement, and the reporting quantity may indicate the type of information the UE 104 is to report. In some examples, the reporting configuration 504 may include a CSI reporting configuration, and the reporting quantity may include a CSI reporting quantity. Additionally, or alternatively, the reporting configuration 504 may indicate an uplink configuration that includes a set of uplink resources within which the UE 104 supports uplink transmissions (e.g., within which the UE 104 may be allowed to perform uplink transmissions).

In some implementations, the UE 104 may identify (e.g., compute, determine, receive, derive) at least one NZP downlink reference signal resource for channel measurement based on the downlink reference signal configuration. Using the partial DL-UL reciprocity capability, the UE 104 may derive uplink-relevant channel information from such downlink measurements. The UE 104 may transmit a report 506 (e.g., a CSI report) including a value indicating the reporting quantity based on the capability, the reporting configuration 504, and the at least one NZP downlink reference signal resource. The report 506 may enable the NE 102 to schedule uplink transmissions more efficiently without relying solely on uplink SRSs. In some implementations, the UE 104 may operate in a TDD frequency band.

In some examples, the at least partial DL-UL reciprocity includes a capability according to which the UE 104 may infer at least a portion of an uplink channel over which an uplink symbol is conveyed on an uplink antenna port from at least a portion of a downlink channel over which a downlink symbol is conveyed on a downlink antenna port. The uplink antenna port and the downlink antenna port may correspond to the same antenna port used for both downlink reception and uplink transmission. Alternatively, the uplink antenna port used for uplink transmission may be the same as the downlink antenna port used for downlink reception. In some examples, a phase difference between the at least partial uplink channel and the at least partial downlink channel may correspond to a constant offset within a specified time window. In some other examples, a relative phase difference of the at least partial uplink channel between any two uplink antenna ports compared to a relative phase difference of the at least partial downlink channel between any two downlink antenna ports may be below a threshold of a maximum allowable difference of relative phase error within a time window from a last received NZP downlink reference signal resource. In yet another example, a relative power or amplitude difference of the at least partial uplink channel between any two uplink antenna ports compared to a relative power or amplitude difference of the at least partial downlink channel between any two downlink antenna ports may be below a threshold of a maximum allowable difference of relative power or amplitude error within a time window from a last received NZP downlink reference signal resource.

In some examples, the at least partial DL-UL reciprocity may include at least a partial calibration that controls (e.g., manages) a mismatch of one or more of a relative phase, an amplitude, or a power between an uplink transmit and RF radio signal path or chain associated with at least one uplink antenna port, and a downlink receive and RF radio signal path or chain associated with at least one downlink antenna port at the UE 104. As such, a mismatch between the relative phase, amplitude, or power between the uplink and downlink signals may be within a calibration error threshold. The uplink transmit and RF radio signal path or chain may include a signal path from a baseband transmitter/transceiver of the UE 104 to an antenna array corresponding to the at least one uplink (e.g., transmit) antenna port. The downlink receive and RF radio signal path or chain may include a signal path from an antenna array corresponding to the at least one downlink (e.g., receive) antenna port to a baseband receiver/transceiver of the UE 104. In some examples, for relative phase mismatch, the calibration error threshold may correspond to a maximum allowable relative phase error within a specified time window from a last received NZP downlink reference signal resource. In a case of relative power or amplitude mismatch, the calibration error threshold may correspond to a maximum allowable relative power or amplitude error within a specified time window from a last received NZP downlink reference signal resource. In some examples, a common phase rotation between the uplink signal paths may not be considered as a calibration mismatch. In some other examples, if a relative difference between the relative phase, power, or amplitude between any two uplink signal paths compared to the relative phase, power, or amplitude between any two downlink signal paths is larger than the calibration error threshold for relative phase, power, or amplitude error, then there may be a relative phase, power, or amplitude calibration mismatch. In some examples, the at least partial DL-UL reciprocity may correspond to reciprocity calibration for at least a subset or group of antenna ports.

In some examples, the set of uplink resources may include a set of uplink PRBs. Additionally, or alternatively, the set of uplink resources may include a PUCCH resource set, and the at least one preferred resource subset may include a preferred PUCCH resource from the PUCCH resource set. In some examples, the preferred PUCCH resource may be recommended for transmitting HARQ feedback (e.g., indications) associated with a received downlink transport block. The at least one preferred resource subset may include a preferred semi-statically configured or configured grant uplink resource for transmitting periodic or semi-persistent uplink information. Additionally, or alternatively, the set of uplink resources may include a set of possible semi-statically configured or configured grant uplink resources, and the UE may select the preferred semi-statically configured or configured grant uplink resource from the set of possible semi-statically configured or configured grant uplink resources.

In some implementations, the reporting quantity may indicate an uplink channel representation. The UE 104 may identify (e.g., derive, compute, determine, receive) the uplink channel representation based on the received one or more NZP downlink reference signal resources and the at least partial DL-UL reciprocity capability. In some examples, the uplink channel representation may be associated with the at least one preferred resource subset. Additionally, or alternatively, the uplink channel representation may include a preferred uplink precoder matrix selected from an uplink precoder codebook. The uplink precoder codebook may be a fixed codebook or a configurable codebook that is one or more of downloadable, uploadable, or parameterized. Alternatively, the uplink precoder codebook may be based on a Discrete Fourier Transform (DFT)-based codebook and may include an antenna-selection codebook. In some examples, configuration-based parameters associated with the uplink precoder codebook may include a number of uplink antenna ports, an uplink antenna configuration (e.g., including uplink transmit antenna structures), antenna layouts including uniform, non-uniform, or irregular layouts, or antenna properties such as directional or omnidirectional antenna characteristics. Additionally, or alternatively, the uplink channel representation may include a representation of an uplink channel spatial covariance matrix. The reporting configuration 504 may indicate and configure the uplink precoder codebook for the UE 104. In some examples, the reporting configuration 504 may indicate an uplink codebook subset restriction, which may restrict the precoder indication to a subset of the precoders in the uplink codebook. In some examples, the uplink channel representation may include explicit channel information such as eigenvectors corresponding to at least the dominant eigenvalues (e.g., eigenvalues larger than a threshold) or X number of the largest eigenvalues (e.g., eigenvalues larger than a threshold).

In some examples, the reporting quantity may indicate a subset or group of uplink antenna ports selected from a set of uplink antenna ports, where the subset or group of uplink antenna ports may be associated with the at least one preferred resource subset. In some implementations, the reporting configuration 504 may indicate an interference measurement resource configuration. In such cases, the UE 104 may compute (e.g., derive, determine, identify) a value for a CSI reporting quantity based on the received at least one NZP downlink reference signal resource, the interference measurement resource, and the at least partial DL-UL reciprocity capability. The interference measurement resource may include at least one of a downlink zero-power (ZP) reference signal or a downlink reference signal configured for interference measurement. In some examples, the UE 104 may receive at least one NZP downlink reference signal resource for interference measurement, including, for example, an NZP downlink reference signal transmitted from a non-serving cell. Additionally, or alternatively, the interference measurement resource may include uplink resources such as time-frequency resources in uplink symbols and/or slots.

The UE 104 may receive an indication of an SRS configuration and determine, based on the received at least one NZP downlink reference signal resource and the at least partial DL-UL reciprocity, a preferred uplink precoder matrix associated with the at least one preferred resource subset. Additionally, in such cases, the UE 104 may transmit at least one SRS on an SRS resource associated with the SRS configuration. The UE 104 may precode the at least one SRS using the determined preferred uplink precoder matrix. In some examples, the UE 104 may receive an uplink scheduling message indicating at least one of the at least one preferred resource subset or an indication of the SRS resource corresponding to the precoded SRS. The uplink scheduling message may schedule the UE 104 for uplink data transmission on the at least one preferred resource subset. The UE 104 may precode the uplink data based on the preferred uplink precoder matrix and transmit the precoded uplink data on the at least one preferred resource subset. In some examples, spatial relation information or an uplink TCI state of the SRS resource may include the at least one NZP downlink reference signal resource as a source reference signal for determining an uplink spatial domain transmission filter for the SRS transmission. Alternatively, the at least one NZP downlink reference signal resource and the SRS resource may be associated with a joint downlink/uplink TCI state providing a common source reference signal used for determining both downlink QCL information for receiving the at least one NZP downlink reference signal resource and an uplink spatial transmission filter for the SRS resource.

In some examples, the reporting configuration 504 may include an indication to generate and transmit the report 506 according to one of periodic reporting and semi-persistent reporting with a configured periodicity (e.g., indicated in the reporting configuration 504). In some examples, the UE 104 may receive an indication that activates the reporting configuration 504 (e.g., semi-persistent reporting), and in response to receiving the indication that activates the reporting configuration 504, the UE 104 may initiate generation and transmission of the report 506. Generation of the report 506 may include determining (e.g., identifying, selecting, receiving, computing, deriving) the reporting quantity. In some examples, the UE 104 may receive an indication that deactivates the reporting configuration 504 and, in response to receiving the indication that deactivates the reporting configuration 504, the UE 104 may stop generation and transmission of the report 506. In some examples, the UE 104 may receive an indication that activates the reporting configuration 504 via higher-layer signaling in a MAC-CE or via DCI. In some examples, the UE 104 may receive an indication in a DCI that triggers the reporting configuration 504, and in response to receiving the indication, the UE 104 may initiate generation and transmission of the report 506.

In some examples, the reporting configuration 504 may include an indication that initiates generation and transmission of the report 506 when a trigger condition is satisfied. The trigger condition may correspond to one or more of an L1-RSRP, an L1-SINR, or downlink radio link quality based on a downlink reference signal (e.g., a downlink radio link quality of the at least one NZP downlink reference signal is below a first threshold, such as an RSRP or SINR threshold). In some examples, the reporting configuration 504 may configure the trigger condition (e.g., an RSRP or SINR threshold). Additionally, or alternatively, the NE 102 may configure the UE 104 to transmit an indication that the trigger condition is satisfied prior to transmitting the report 506. In some examples, the UE 104 may receive uplink resource-allocation information and transmit the report 506 using resources associated with the received uplink resource-allocation information.

In some examples, the UE 104 may be configured to transmit multiple (NRep) reports 506 corresponding to different reporting configurations 504 (e.g., CSI for uplink resource selection and preferred uplink resources, CSI for uplink channel representation, such as an uplink TPMI, CSI for PDCCH, CSI for physical downlink shared channel (PDSCH) scheduling, CSI part 1, CSI part 2, wideband/subband reports, different cells, and so forth). In such examples, the UE 104 may prioritize one or more reports 506. The priority of each of the NRep reports 506 may be based on one or more factors. For example, a report 506 corresponding to one reporting configuration 504 for one cell may have higher priority compared with another report 506 corresponding to another reporting configuration 504 for the same cell. Additionally, or alternatively, reports 506 intended for one cell may have higher priorities compared with other reports 506 intended for another cell. Additionally, or alternatively, a report 506 may have higher priority based on the content of the report 506 (e.g., reports 506 carrying L1-RSRP information have higher priority than reports 506 for one or more of uplink resource selection, preferred uplink resource, or uplink channel representation such as uplink TPMI, uplink channel spatial covariance matrix, explicit uplink channel information). Additionally, or alternatively, a report 506 may have a higher priority than CSI for PDSCH. Additionally, or alternatively, a report 506 may have higher priority based on its type. For example, whether the report 506 is aperiodic, semi-persistent, or periodic, and whether the UE 104 transmits the report 506 via physical uplink shared channel (PUSCH) or PUCCH may impact the priority of the report 506. In some examples, reports 506 with lower IDs may have higher priorities. By way of example, the reports 506 may be prioritized according to Pri_{iCSI}(y, k, c, s)=3·N_{cells}·Mₛ·y+N_{cells}·Mₛ·k+Mₛ·c+s, where s may represent a reporting configuration index, Mₛ may represent a maximum number of reporting configurations 504, c may represent a cell index, N_{cells} may represent a number of serving cells, k may be 0 for reports 506 carrying L1-RSRP or L1-SINR, 1 for reports 506 carrying CSI for one or more of uplink resource selection, preferred uplink resources, or uplink channel representation, or 2 for other cases, and y may be 0 for aperiodic reports 506, 1 for semi-persistent reports 506 on PUSCH, 2 for semi-persistent reports 506 on PUCCH, and 3 for periodic reports 506.

In some examples, the report 506 may include an L1-SINR reporting quantity corresponding to a downlink radio link quality of the at least one NZP downlink reference signal. In some examples, determining the value of the reporting quantity may consume (e.g., utilize, use, occupy) a predetermined number of processing units (e.g., CSI processing units). For example, a single report 506 may use a single CSI processing unit. In some examples, the UE 104 may transmit a report 506 for one uplink configuration or multiple reports 506 corresponding to different reporting configurations 504 with different uplink configurations (e.g., multiple sets of uplink resources, a first reporting configuration 504 for indicating uplink resource selection and preferred uplink resources, and a second reporting configuration 504 for indicating uplink channel representation). In such cases, each report 506 may occupy (e.g., utilize, use) one CSI processing unit.

When the NE 102 configures the UE 104 to transmit multiple reports 506 corresponding to different reporting configurations 504 for uplink (e.g., CSI for one or more of uplink resource selection, preferred uplink resources, or uplink channel representation) and downlink (e.g., CSI for PDCCH, CSI for PDSCH scheduling), the NE 102 may also configure the UE 104 with a separate number of simultaneous CSI processing units for uplink and downlink. Alternatively, the NE 102 may configure the UE 104 with a total number of simultaneous CSI processing units for uplink and downlink. In some examples, the UE 104 may indicate a number of supported simultaneous CSI calculations, N_{CPU}, with a higher-layer parameter simultaneousCSIReportsPerCC in a component carrier, and a higher-layer parameter simultaneousCSI-ReportsAllCC across all component carriers. If the UE 104 supports N_{CPU} simultaneous CSI calculations, the UE 104 may have N_{CPU} CSI processing units for processing reports 506. If L CSI processing units may be occupied (e.g., utilized, used) for reports 506 in a given OFDM symbol, the UE 104 may have N_{CPU}−L unoccupied CSI processing units. If N reports 506 start occupying their respective CSI processing units on the same OFDM symbol on which NcPU-L CPUs may be unoccupied, where each report 506 n=0, . . . , N−1 corresponds to

$${O}_{CPU}^{( n )} ,$$

the UE 104 may not be required to update the N−M requested reports 506 with the lowest priority, where 0≤M≤N is the largest value such that

$${Σ}_{n = 0}^{M - 1} {O}_{C P U}^{( n )} \leq {N}_{C P U} - L$$

holds.

In some examples, the UE 104 may derive (e.g., determine, identify, compute, calculate) the reporting quantity based on reference signals no later than a CSI reference resource. In the frequency domain, the reference resource may be defined by a group of PRBs corresponding to a frequency band to which the derived reporting quantity relates. The frequency band may be the bandwidth of the at least one NZP downlink reference signal resource or a subband corresponding to the set of uplink resources within which uplink transmissions may be supported. In the time domain, the CSI reference resource may be associated with the at least one NZP downlink reference signal resource prior to or in the same slot as the corresponding CSI report request in case of aperiodic CSI reporting or the periodic CSI reporting slot in case of periodic or semi-persistent CSI reporting. In some examples, the NZP downlink reference signal may include at least one of a synchronization reference signal or a reference signal for CSI, such as a CSI-RS.

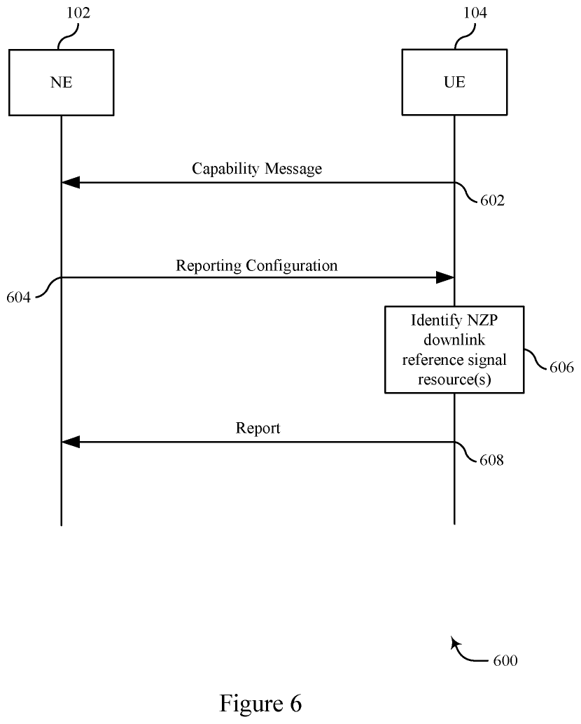

FIG. 6 illustrates an example of a signaling diagram 600 in accordance with aspects of the present disclosure. In some examples, the signaling diagram 600 implements or is implemented by aspects of the wireless communications system 100, the CSI reporting scheme 200, the CSI-AperiodicTriggerState IE 300, the NZP-CSI-RS-Resource IE 400, the CSI-IM-Resource IE 401, and the reciprocity-based resource selection and reporting scheme 500. The signaling diagram 600 may implement or be implemented by NE 102 and UE 104, which may be examples of the corresponding devices as described with reference to FIGS. 1 through 5. Alternatively, examples of the following may be implemented, where some processes may be performed in a different order than described or may not be performed. In some cases, processes may include additional features not mentioned below, or further processes may be added.

At step 602, the UE 104 transmits a capability message to the NE 102. The capability message indicates a capability of the UE 104 to support at least a partial DL-UL reciprocity. The partial DL-UL reciprocity may include a capability according to which at least a portion of an uplink channel over which an uplink symbol on an uplink antenna port is conveyed may be inferred from at least a portion of a downlink channel over which a downlink symbol on a downlink antenna port is conveyed. In some examples, the uplink antenna port and the downlink antenna port correspond to the same antenna port used for both downlink reception and uplink transmission. In some examples, the partial DL-UL reciprocity includes a reciprocity calibration for a set of multiple antenna ports or a subset of the set of multiple antenna ports. The capability message may be transmitted via higher-layer signaling.

At step 604, the NE 102 transmits a reporting configuration to the UE 104 based on the capability indicated in the capability message. The reporting configuration indicates a downlink reference signal configuration and a reporting quantity. The downlink reference signal configuration indicates at least one NZP downlink reference signal resource for channel measurement. In some examples, the reporting configuration further indicates an uplink configuration indicating a set of uplink resources for uplink transmissions. The set of uplink resources may include a set of uplink PRBs, a PUCCH resource set, or a set of possible semi-statically configured or dynamically configured grant uplink resources.

At 606, the UE 104 identifies at least one NZP downlink reference signal resource for channel measurement based on the downlink reference signal configuration. The UE 104 may compute a value for the reporting quantity based on the capability, the at least one NZP downlink reference signal resource, and the partial DL-UL reciprocity capability. In some examples, the UE 104 receives an indication of an SRS configuration from the NE 102. The UE 104 determines, based on the capability and the at least one NZP downlink reference signal resource, an uplink precoder matrix associated with at least one subset of resources. The UE 104 transmits at least one SRS on an SRS resource associated with the SRS configuration, where the at least one SRS is precoded based on the uplink precoder matrix. In some examples, the UE 104 receives an uplink scheduling message indicating the at least one subset of resources and the indication of the SRS resource corresponding to the at least one precoded SRS. The UE 104 precodes uplink data based on the uplink precoder matrix and transmits the precoded uplink data on the at least one subset of resources.

In some examples, the UE 104 receives an indication that activates the reporting configuration. In response to receiving the indication that activates the reporting configuration, the UE 104 initiates generation and transmission of the report. In some examples, the UE 104 receives an indication that deactivates the reporting configuration. In response to receiving the indication that deactivates the reporting configuration, the UE 104 stops generation and transmission of the report.

At step 608, the UE 104 transmits a report to the NE 102. The report includes a value indicating the reporting quantity based on the capability, the reporting configuration, and the at least one NZP downlink reference signal resource. The report may indicate at least one preferred resource subset from the set of uplink resources for uplink transmission from the UE 104. In some examples, the report includes an uplink channel representation, such as a preferred uplink precoder matrix or a representation of an uplink channel spatial covariance matrix. The NE 102 may use the information in the report to schedule uplink transmissions for the UE 104 more efficiently without relying solely on uplink SRSs.

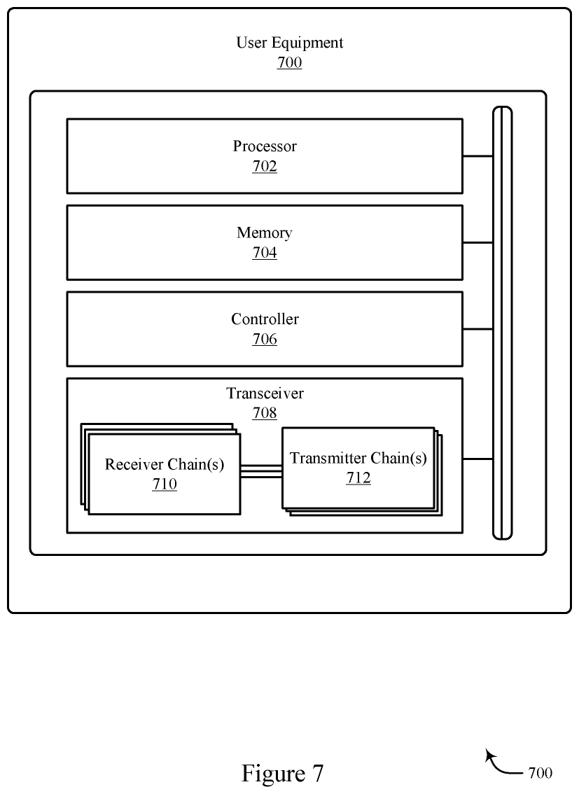

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for transmitting a capability message indicating a capability of the UE to support at least a partial DL-UL reciprocity, receiving, based on the capability, a reporting configuration indicating a downlink reference signal configuration and a reporting quantity, identifying at least one NZP downlink reference signal resource for channel measurement based on the downlink reference signal configuration, and transmitting a report including a value indicating the reporting quantity based on the capability, the reporting configuration, and the at least one NZP downlink reference signal resource. In this manner, the UE 700 supports improved uplink channel characteristics estimation accuracy by leveraging DL-UL reciprocity, reducing signaling overhead and enhancing overall system throughput by enabling more efficient resource allocation based on channel measurements.

Additionally, the UE 700 may be configured to or operable to support any one or combination of where the reporting configuration further indicates an uplink configuration indicating a set of uplink resources for uplink transmissions, and the UE 700 may be configured to or operable to support determining the value indicating the reporting quantity based on the capability, the at least one NZP downlink reference signal resource, and the uplink configuration, where the reporting quantity indicates at least one subset of resources of the set of uplink resources that is preferred for the uplink transmissions. This aspect enables optimized resource selection for uplink transmissions, improving throughput and reducing latency by identifying preferred uplink resources based on channel conditions. Additionally, or alternatively, the UE 700 may be configured to or operable to support where the at least one subset of resources includes at least one of a semi-statically configured resource or a configured grant uplink resource that is preferred for the uplink transmissions. This aspect enhances transmission reliability by enabling flexible resource allocation that accommodates both scheduled and grant-free uplink transmissions. Additionally, or alternatively, the UE 700 may be configured to or operable to support where the reporting quantity includes an indication of an uplink channel representation associated with the at least one subset of resources, where the uplink channel representation is based on the capability and the at least one NZP downlink reference signal resource. This aspect improves uplink beamforming accuracy by providing channel representation information derived from downlink measurements, enhancing overall system performance. Additionally, or alternatively, the UE 700 may be configured to or operable to support where the uplink channel representation includes at least one of a preferred uplink precoder matrix from an uplink precoder codebook or a representation of an uplink channel spatial covariance matrix. This aspect enables precise precoding selection for uplink transmissions, maximizing signal quality and improving data throughput. Additionally, or alternatively, the UE 700 may be configured to or operable to support receiving an indication of an SRS configuration, determining, based on the capability and the at least one NZP downlink reference signal resource, an uplink precoder matrix associated with the at least one subset of resources, and transmitting at least one SRS on an SRS resource associated with the SRS configuration, where the at least one SRS is precoded based on the uplink precoder matrix. This aspect improves channel sounding efficiency by enabling precoded SRS transmissions that leverage reciprocity-based precoder selection, reducing network overhead for uplink signaling.

Additionally, or alternatively, the UE 700 may be configured to or operable to support receiving an uplink scheduling message indicating the at least one subset of resources and the indication of the SRS resource corresponding to the at least one precoded SRS, precoding uplink data based on the uplink precoder matrix, and transmitting the precoded uplink data on the at least one subset of resources. This aspect enables coordinated uplink data transmission with optimized precoding, improving data reliability and spectral efficiency. Additionally, or alternatively, the UE 700 may be configured to or operable to support inferring at least a portion of an uplink channel over which an uplink symbol on an uplink antenna port is conveyed based on at least a portion of a downlink channel over which a downlink symbol on a downlink antenna port is conveyed. This aspect reduces uplink reference signal overhead by enabling channel inference from downlink measurements, improving overall system efficiency. Additionally, or alternatively, the UE 700 may be configured to or operable to support where a phase difference between the portion of the uplink channel and the portion of the downlink channel is a constant offset within a time window. This aspect ensures stable reciprocity-based channel estimation by maintaining predictable phase relationships, improving precoding accuracy and transmission reliability. Additionally, or alternatively, the UE 700 may be configured to or operable to support where a relative phase difference of the portion of the uplink channel between any two uplink antenna ports compared to a relative phase difference of the portion of the downlink channel between any two downlink antenna ports is below a threshold of a maximum allowable difference of relative phase error within a time window from a last received NZP downlink reference signal resource. This aspect ensures accurate multi-antenna precoding by controlling phase calibration errors, enhancing beamforming performance and signal quality. Additionally, or alternatively, the UE 700 may be configured to or operable to support where a relative power difference of the portion of the uplink channel between any two uplink antenna ports compared to a relative power difference of the portion of the downlink channel between any two downlink antenna ports is below a threshold of a maximum allowable difference of relative power error within a time window from a last received NZP downlink reference signal resource. This aspect ensures accurate power calibration across antenna ports, improving transmission efficiency and reducing interference. Additionally, or alternatively, the UE 700 may be configured to or operable to support where the partial DL-UL reciprocity includes a reciprocity calibration for a set of multiple antenna ports or a subset of the set of multiple antenna ports. This aspect enables flexible calibration configurations that accommodate varying hardware capabilities, improving system adaptability and performance across different UE implementations. Additionally, or alternatively, the UE 700 may be configured to or operable to support where the reporting configuration further includes an indication of an interference measurement resource configuration, and the UE 700 may be configured to or operable to support determining, based on the capability, the at least one NZP downlink reference signal resource, and the interference measurement resource configuration, the value indicating the reporting quantity. This aspect enables interference-aware resource selection, improving transmission reliability and reducing interference impact on uplink communications.

Additionally, or alternatively, the UE 700 may be configured to or operable to support where the reporting configuration includes an indication to generate and transmit the report periodically or semi-persistently with a configured periodicity. This aspect enables efficient channel tracking through periodic reporting, maintaining accurate CSI while balancing signaling overhead. Additionally, or alternatively, the UE 700 may be configured to or operable to support receiving an indication that activates the reporting configuration, and initiating generation and transmission of the report based on the activation of the reporting configuration. This aspect enables dynamic control of reporting behavior, reducing unnecessary signaling when reciprocity-based reporting is not needed. Additionally, or alternatively, the UE 700 may be configured to or operable to support receiving an indication that deactivates the reporting configuration, and stopping generation and transmission of the report based on the deactivation of the reporting configuration. This aspect conserves UE resources and reduces signaling overhead by disabling reporting when no longer required. Additionally, or alternatively, the UE 700 may be configured to or operable to support initiating generation and transmission of the report based on a trigger condition failing to satisfy a threshold, where the trigger condition includes a downlink radio link quality associated with an NZP downlink reference signal. This aspect enables event-driven reporting that responds to channel quality changes, improving system responsiveness and ensuring timely updates when channel conditions degrade.

Additionally, or alternatively, the UE 700 may support at least one memory (e.g., the memory 704) and at least one processor (e.g., the processor 702) coupled with the at least one memory and configured to cause the UE to transmit a capability message indicating a capability of the UE to support at least a partial DL-UL reciprocity, receive, based on the capability, a reporting configuration indicating a downlink reference signal configuration and a reporting quantity, identify at least one NZP downlink reference signal resource for channel measurement based on the downlink reference signal configuration, and transmit a report including a value indicating the reporting quantity based on the capability, the reporting configuration, and the at least one NZP downlink reference signal resource. In this manner, the UE 700 supports improved uplink channel characteristics estimation by leveraging DL-UL reciprocity, reducing signaling overhead and enhancing spectral efficiency for uplink transmissions.

Additionally, the UE 700 may be configured to support any one or combination of where the reporting configuration further indicates an uplink configuration indicating a set of uplink resources for uplink transmissions, and the UE 700 may be configured to support determining the value indicating the reporting quantity based on the capability, the at least one NZP downlink reference signal resource, and the uplink configuration, where the reporting quantity indicates at least one subset of resources of the set of uplink resources that is preferred for the uplink transmissions. This aspect enables optimized resource selection for uplink transmissions, improving throughput and reducing latency by identifying preferred uplink resources based on channel conditions. Additionally, or alternatively, the UE 700 may be configured to or operable to support where the at least one subset of resources includes at least one of a semi-statically configured resource or a configured grant uplink resource that is preferred for the uplink transmissions. This aspect enhances transmission reliability by enabling flexible resource allocation that accommodates both scheduled and grant-free uplink transmissions. Additionally, or alternatively, the UE 700 may be configured to or operable to support where the reporting quantity includes an indication of an uplink channel representation associated with the at least one subset of resources, where the uplink channel representation is based on the capability and the at least one NZP downlink reference signal resource. This aspect improves uplink beamforming accuracy by providing channel representation information derived from downlink measurements, enhancing overall system performance. Additionally, or alternatively, the UE 700 may be configured to or operable to support where the uplink channel representation includes at least one of a preferred uplink precoder matrix from an uplink precoder codebook or a representation of an uplink channel spatial covariance matrix. This aspect enables precise precoding selection for uplink transmissions, maximizing signal quality and improving data throughput. Additionally, or alternatively, the UE 700 may be configured to or operable to support receiving an indication of an SRS configuration, determining, based on the capability and the at least one NZP downlink reference signal resource, an uplink precoder matrix associated with the at least one subset of resources, and transmitting at least one SRS on an SRS resource associated with the SRS configuration, where the at least one SRS is precoded based on the uplink precoder matrix. This aspect improves channel sounding efficiency by enabling precoded SRS transmissions that leverage reciprocity-based precoder selection, reducing network overhead for uplink signaling.

Additionally, or alternatively, the UE 700 may be configured to or operable to support receiving an uplink scheduling message indicating the at least one subset of resources and the indication of the SRS resource corresponding to the at least one precoded SRS, precoding uplink data based on the uplink precoder matrix, and transmitting the precoded uplink data on the at least one subset of resources. This aspect enables coordinated uplink data transmission with optimized precoding, improving data reliability and spectral efficiency. Additionally, or alternatively, the UE 700 may be configured to or operable to support inferring at least a portion of an uplink channel over which an uplink symbol on an uplink antenna port is conveyed based on at least a portion of a downlink channel over which a downlink symbol on a downlink antenna port is conveyed. This aspect reduces uplink reference signal overhead by enabling channel inference from downlink measurements, improving overall system efficiency. Additionally, or alternatively, the UE 700 may be configured to or operable to support where a phase difference between the portion of the uplink channel and the portion of the downlink channel is a constant offset within a time window. This aspect ensures stable reciprocity-based channel estimation by maintaining predictable phase relationships, improving precoding accuracy and transmission reliability. Additionally, or alternatively, the UE 700 may be configured to or operable to support where a relative phase difference of the portion of the uplink channel between any two uplink antenna ports compared to a relative phase difference of the portion of the downlink channel between any two downlink antenna ports is below a threshold of a maximum allowable difference of relative phase error within a time window from a last received NZP downlink reference signal resource. This aspect ensures accurate multi-antenna precoding by controlling phase calibration errors, enhancing beamforming performance and signal quality. Additionally, or alternatively, the UE 700 may be configured to or operable to support where a relative power difference of the portion of the uplink channel between any two uplink antenna ports compared to a relative power difference of the portion of the downlink channel between any two downlink antenna ports is below a threshold of a maximum allowable difference of relative power error within a time window from a last received NZP downlink reference signal resource. This aspect ensures accurate power calibration balanced power distribution across antenna ports, improving transmission efficiency and reducing interference. Additionally, or alternatively, the UE 700 may be configured to or operable to support where the partial DL-UL reciprocity includes a reciprocity calibration for a set of multiple antenna ports or a subset of the set of multiple antenna ports. This aspect enables flexible calibration configurations that accommodate varying hardware capabilities, improving system adaptability and performance across different UE implementations. Additionally, or alternatively, the UE 700 may be configured to or operable to support where the reporting configuration further includes an indication of an interference measurement resource configuration, and determining, based on the capability, the at least one NZP downlink reference signal resource, and the interference measurement resource configuration, the value indicating the reporting quantity. This aspect enables interference-aware resource selection, improving transmission reliability and reducing interference impact on uplink communications.

Additionally, or alternatively, the UE 700 may be configured to or operable to support where the reporting configuration includes an indication to generate and transmit the report periodically or semi-persistently with a configured periodicity. This aspect enables efficient channel tracking through periodic reporting, maintaining accurate CSI while balancing signaling overhead. Additionally, or alternatively, the UE 700 may be configured to or operable to support receiving an indication that activates the reporting configuration, and initiating generation and transmission of the report based on the activation of the reporting configuration. This aspect enables dynamic control of reporting behavior, reducing unnecessary signaling when reciprocity-based reporting is not needed. Additionally, or alternatively, the UE 700 may be configured to or operable to support receiving an indication that deactivates the reporting configuration, and stopping generation and transmission of the report based on the deactivation of the reporting configuration. This aspect conserves UE resources and reduces signaling overhead by disabling reporting when no longer required. Additionally, or alternatively, the UE 700 may be configured to or operable to support initiating generation and transmission of the report based on a trigger condition failing to satisfy a threshold, where the trigger condition includes a downlink radio link quality associated with an NZP downlink reference signal. This aspect enables event-driven reporting that responds to channel quality changes, improving system responsiveness and ensuring timely updates when channel conditions degrade.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

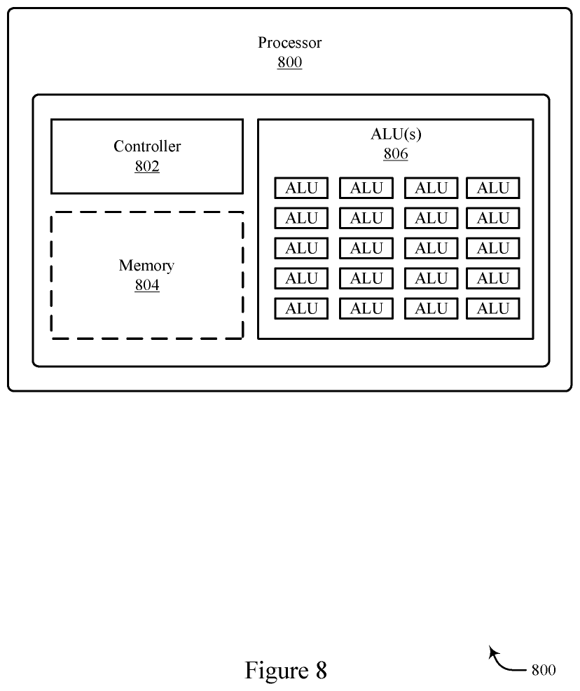

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to transmit a capability message indicating a capability of the UE to support at least a partial DL-UL reciprocity, receive, based on the capability, a reporting configuration indicating a downlink reference signal configuration and a reporting quantity, identify at least one NZP downlink reference signal resource for channel measurement based on the downlink reference signal configuration, and transmit a report including a value indicating the reporting quantity based on the capability, the reporting configuration, and the at least one NZP downlink reference signal resource. In this manner, the processor 800 supports improved uplink channel characteristics estimation by leveraging DL-UL reciprocity, reducing signaling overhead and enhancing spectral efficiency for uplink transmissions.

Additionally, the processor 800 may be configured to support any one or combination of where the reporting configuration further indicates an uplink configuration indicating a set of uplink resources for uplink transmissions, and the processor 800 may be configured to support determining the value indicating the reporting quantity based on the capability, the at least one NZP downlink reference signal resource, and the uplink configuration, where the reporting quantity indicates at least one subset of resources of the set of uplink resources that is preferred for the uplink transmissions. This aspect enables optimized resource selection for uplink transmissions, improving throughput and reducing latency by identifying preferred uplink resources based on channel conditions. Additionally, or alternatively, the processor 800 may be configured to or operable to support where the at least one subset of resources includes at least one of a semi-statically configured resource or a configured grant uplink resource that is preferred for the uplink transmissions. This aspect enhances transmission reliability by enabling flexible resource allocation that accommodates both scheduled and grant-free uplink transmissions. Additionally, or alternatively, the processor 800 may be configured to or operable to support where the reporting quantity includes an indication of an uplink channel representation associated with the at least one subset of resources, where the uplink channel representation is based on the capability and the at least one NZP downlink reference signal resource. This aspect improves uplink beamforming accuracy by providing channel representation information derived from downlink measurements, enhancing overall system performance. Additionally, or alternatively, the processor 800 may be configured to or operable to support where the uplink channel representation includes at least one of a preferred uplink precoder matrix from an uplink precoder codebook or a representation of an uplink channel spatial covariance matrix. This aspect enables precise precoding selection for uplink transmissions, maximizing signal quality and improving data throughput. Additionally, or alternatively, the processor 800 may be configured to or operable to support receiving an indication of an SRS configuration, determining, based on the capability and the at least one NZP downlink reference signal resource, an uplink precoder matrix associated with the at least one subset of resources, and transmitting at least one SRS on an SRS resource associated with the SRS configuration, where the at least one SRS is precoded based on the uplink precoder matrix. This aspect improves channel sounding efficiency by enabling precoded SRS transmissions that leverage reciprocity-based precoder selection, reducing network overhead for uplink signaling.

Additionally, or alternatively, the processor 800 may be configured to or operable to support receiving an uplink scheduling message indicating the at least one subset of resources and the indication of the SRS resource corresponding to the at least one precoded SRS, precoding uplink data based on the uplink precoder matrix, and transmitting the precoded uplink data on the at least one subset of resources. This aspect enables coordinated uplink data transmission with optimized precoding, improving data reliability and spectral efficiency. Additionally, or alternatively, the processor 800 may be configured to or operable to support inferring at least a portion of an uplink channel over which an uplink symbol on an uplink antenna port is conveyed based on at least a portion of a downlink channel over which a downlink symbol on a downlink antenna port is conveyed. This aspect reduces uplink reference signal overhead by enabling channel inference from downlink measurements, improving overall system efficiency. Additionally, or alternatively, the processor 800 may be configured to or operable to support where a phase difference between the portion of the uplink channel and the portion of the downlink channel is a constant offset within a time window. This aspect ensures stable reciprocity-based channel estimation by maintaining predictable phase relationships, improving precoding accuracy and transmission reliability. Additionally, or alternatively, the processor 800 may be configured to or operable to support where a relative phase difference of the portion of the uplink channel between any two uplink antenna ports compared to a relative phase difference of the portion of the downlink channel between any two downlink antenna ports is below a threshold of a maximum allowable difference of relative phase error within a time window from a last received NZP downlink reference signal resource. This aspect ensures accurate multi-antenna precoding by controlling phase calibration errors, enhancing beamforming performance and signal quality. Additionally, or alternatively, the processor 800 may be configured to or operable to support where a relative power difference of the portion of the uplink channel between any two uplink antenna ports compared to a relative power difference of the portion of the downlink channel between any two downlink antenna ports is below a threshold of a maximum allowable difference of relative power error within a time window from a last received NZP downlink reference signal resource. This aspect ensures accurate power calibration across antenna ports, improving transmission efficiency and reducing interference. Additionally, or alternatively, the processor 800 may be configured to or operable to support where the partial DL-UL reciprocity includes a reciprocity calibration for a set of multiple antenna ports or a subset of the set of multiple antenna ports. This aspect enables flexible calibration configurations that accommodate varying hardware capabilities, improving system adaptability and performance across different UE implementations. Additionally, or alternatively, the processor 800 may be configured to or operable to support where the reporting configuration further includes an indication of an interference measurement resource configuration, and determining, based on the capability, the at least one NZP downlink reference signal resource, and the interference measurement resource configuration, the value indicating the reporting quantity. This aspect enables interference-aware resource selection, improving transmission reliability and reducing interference impact on uplink communications.

Additionally, or alternatively, the processor 800 may be configured to or operable to support where the reporting configuration includes an indication to generate and transmit the report periodically or semi-persistently with a configured periodicity. This aspect enables efficient channel tracking through periodic reporting, maintaining accurate CSI while balancing signaling overhead. Additionally, or alternatively, the processor 800 may be configured to or operable to support receiving an indication that activates the reporting configuration, and initiating generation and transmission of the report based on the activation of the reporting configuration. This aspect enables dynamic control of reporting behavior, reducing unnecessary signaling when reciprocity-based reporting is not needed. Additionally, or alternatively, the processor 800 may be configured to or operable to support receiving an indication that deactivates the reporting configuration, and stopping generation and transmission of the report based on the deactivation of the reporting configuration. This aspect conserves UE resources and reduces signaling overhead by disabling reporting when no longer required. Additionally, or alternatively, the processor 800 may be configured to or operable to support initiating generation and transmission of the report based on a trigger condition failing to satisfy a threshold, where the trigger condition includes a downlink radio link quality associated with an NZP downlink reference signal. This aspect enables event-driven reporting that responds to channel quality changes, improving system responsiveness and ensuring timely updates when channel conditions degrade.

Additionally, or alternatively, the processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive a capability message indicating a capability of a UE to support at least a partial DL-UL reciprocity, transmit, based on the capability, a reporting configuration indicating a downlink reference signal configuration and a reporting quantity, the downlink reference signal configuration indicating at least one NZP downlink reference signal resource for channel measurement, and receive a report including a value indicating the reporting quantity based on the capability, the reporting configuration, and the at least one NZP downlink reference signal resource. In this manner, the processor 800 supports improved uplink channel characteristics estimation by leveraging DL-UL reciprocity, reducing signaling overhead and enhancing spectral efficiency for uplink transmissions.

Additionally, the processor 800 may be configured to support any one or combination of where the reporting configuration further indicates an uplink configuration indicating a set of uplink resources for uplink transmissions, where the value indicating the reporting quantity is based on the capability, the at least one NZP downlink reference signal resource, and the uplink configuration, and where the reporting quantity indicates at least one subset of resources of the set of uplink resources that is preferred for the uplink transmissions. This aspect enables optimized resource selection for uplink transmissions, improving throughput and reducing latency by identifying preferred uplink resources based on channel conditions. Additionally, or alternatively, the processor 800 may be configured to or operable to support where the at least one subset of resources includes at least one of a semi-statically configured resource or a configured grant uplink resource that is preferred for the uplink transmissions. This aspect enhances transmission reliability by enabling flexible resource allocation that accommodates both scheduled and grant-free uplink transmissions. Additionally, or alternatively, the processor 800 may be configured to or operable to support where the reporting quantity includes an indication of an uplink channel representation associated with the at least one subset of resources, where the uplink channel representation is based on the capability and the at least one NZP downlink reference signal resource. This aspect improves uplink beamforming accuracy by providing channel representation information derived from downlink measurements, enhancing overall system performance. Additionally, or alternatively, the processor 800 may be configured to or operable to support where the uplink channel representation includes at least one of a preferred uplink precoder matrix from an uplink precoder codebook or a representation of an uplink channel spatial covariance matrix. This aspect enables precise precoding selection for uplink transmissions, maximizing signal quality and improving data throughput. Additionally, or alternatively, the processor 800 may be configured to or operable to support transmitting an indication of an SRS configuration, and receiving at least one SRS on an SRS resource associated with the SRS configuration, where the at least one SRS is precoded based on an uplink precoder matrix associated with the at least one subset of resources, the uplink precoder matrix based on the capability and the at least one NZP downlink reference signal resource. This aspect improves channel sounding efficiency by enabling precoded SRS transmissions that leverage reciprocity-based precoder selection, reducing network overhead for uplink signaling.

Additionally, or alternatively, the processor 800 may be configured to or operable to support transmitting an uplink scheduling message indicating the at least one subset of resources and the indication of the SRS resource corresponding to the at least one precoded SRS, and receiving uplink data on the at least one subset of resources, where the uplink data is precoded based on the uplink precoder matrix. This aspect enables coordinated uplink data transmission with optimized precoding, improving data reliability and spectral efficiency. Additionally, or alternatively, the processor 800 may be configured to or operable to support where at least a portion of an uplink channel over which an uplink symbol on an uplink antenna port is conveyed is inferable based on at least a portion of a downlink channel over which a downlink symbol on a downlink antenna port is conveyed. This aspect reduces uplink reference signal overhead by enabling channel inference from downlink measurements, improving overall system efficiency. Additionally, or alternatively, the processor 800 may be configured to or operable to support where a phase difference between the portion of the uplink channel and the portion of the downlink channel is a constant offset within a time window. This aspect ensures stable reciprocity-based channel estimation by maintaining predictable phase relationships, improving precoding accuracy and transmission reliability. Additionally, or alternatively, the processor 800 may be configured to or operable to support where a relative phase difference of the portion of the uplink channel between any two uplink antenna ports compared to a relative phase difference of the portion of the downlink channel between any two downlink antenna ports is below a threshold of a maximum allowable difference of relative phase error within a time window from a last received NZP downlink reference signal resource. This aspect ensures accurate multi-antenna precoding by controlling phase calibration errors, enhancing beamforming performance and signal quality. Additionally, or alternatively, the processor 800 may be configured to or operable to support where a relative power difference of the portion of the uplink channel between any two uplink antenna ports compared to a relative power difference of the portion of the downlink channel between any two downlink antenna ports is below a threshold of a maximum allowable difference of relative power error within a time window from a last received NZP downlink reference signal resource. This aspect ensures accurate power calibration across antenna ports, improving transmission efficiency and reducing interference. Additionally, or alternatively, the processor 800 may be configured to or operable to support where the partial DL-UL reciprocity includes a reciprocity calibration for a set of multiple antenna ports or a subset of the set of multiple antenna ports. This aspect enables flexible calibration configurations that accommodate varying hardware capabilities, improving system adaptability and performance across different UE implementations. Additionally, or alternatively, the processor 800 may be configured to or operable to support where the reporting configuration further includes an indication of an interference measurement resource configuration, and the value indicating the reporting quantity is based on the capability, the at least one NZP downlink reference signal resource, and the interference measurement resource configuration. This aspect enables interference-aware resource selection, improving transmission reliability and reducing interference impact on uplink communications.

Additionally, or alternatively, the processor 800 may be configured to or operable to support where the reporting configuration includes an indication to generate and transmit the report periodically or semi-persistently with a configured periodicity. This aspect enables efficient channel tracking through periodic reporting, maintaining accurate CSI while balancing signaling overhead. Additionally, or alternatively, the processor 800 may be configured to or operable to support transmitting an indication that activates the reporting configuration, where the activation of the reporting configuration initiates generation and transmission of the report. This aspect enables dynamic control of reporting behavior, reducing unnecessary signaling when reciprocity-based reporting is not needed. Additionally, or alternatively, the processor 800 may be configured to or operable to support transmitting an indication that deactivates the reporting configuration, where the deactivation of the reporting configuration stops generation and transmission of the report. This aspect conserves UE resources and reduces signaling overhead by disabling reporting when no longer required. Additionally, or alternatively, the processor 800 may be configured to or operable to support where the report is received based on a trigger condition failing to satisfy a threshold, where the trigger condition includes a downlink radio link quality associated with an NZP downlink reference signal. This aspect enables event-driven reporting that responds to channel quality changes, improving system responsiveness and ensuring timely updates when channel conditions degrade.

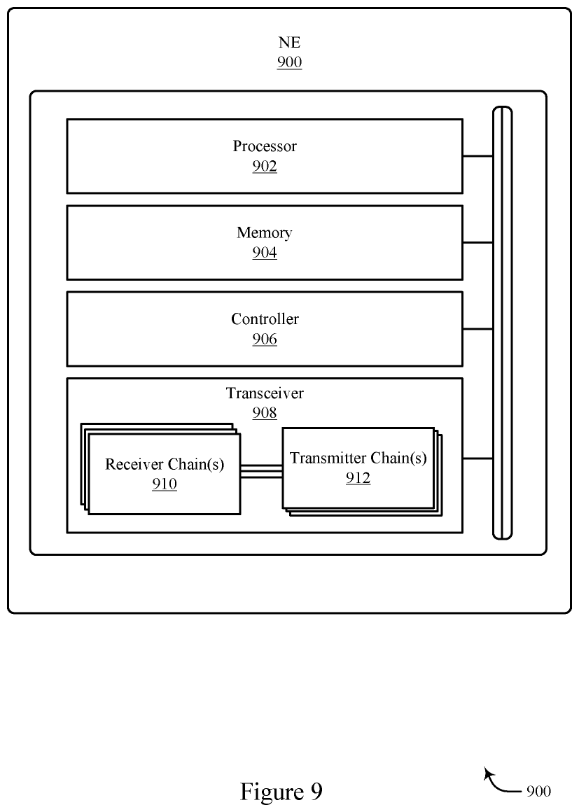

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media include both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for receiving a capability message indicating a capability of a UE to support at least a partial DL-UL reciprocity, transmitting, based on the capability, a reporting configuration indicating a downlink reference signal configuration and a reporting quantity, the downlink reference signal configuration indicating at least one NZP downlink reference signal resource for channel measurement, and receiving a report including a value indicating the reporting quantity based on the capability, the reporting configuration, and the at least one NZP downlink reference signal resource. In this manner, the NE 900 supports improved uplink channel characteristics estimation accuracy by leveraging DL-UL reciprocity, reducing signaling overhead and enhancing overall system throughput by enabling more efficient resource allocation based on channel measurements.

Additionally, the NE 900 may be configured to or operable to support any one or combination of the following: where the reporting configuration further indicates an uplink configuration indicating a set of uplink resources for uplink transmissions, where the value indicating the reporting quantity is based on the capability, the at least one NZP downlink reference signal resource, and the uplink configuration, and where the reporting quantity indicates at least one subset of resources of the set of uplink resources that is preferred for the uplink transmissions. This aspect enables optimized resource selection for uplink transmissions, improving throughput and reducing latency by identifying preferred uplink resources based on channel conditions. Additionally, or alternatively, the NE 900 may be configured to or operable to support where the at least one subset of resources includes at least one of a semi-statically configured resource or a configured grant uplink resource that is preferred for the uplink transmissions. This aspect enhances transmission reliability by enabling flexible resource allocation that accommodates both scheduled and grant-free uplink transmissions. Additionally, or alternatively, the NE 900 may be configured to or operable to support where the reporting quantity includes an indication of an uplink channel representation associated with the at least one subset of resources, where the uplink channel representation is based on the capability and the at least one NZP downlink reference signal resource. This aspect improves uplink beamforming accuracy by providing channel representation information derived from downlink measurements, enhancing overall system performance.

Additionally, or alternatively, the NE 900 may be configured to or operable to support where the uplink channel representation includes at least one of a preferred uplink precoder matrix from an uplink precoder codebook or a representation of an uplink channel spatial covariance matrix. This aspect enables precise precoding selection for uplink transmissions, maximizing signal quality and improving data throughput. Additionally, or alternatively, the NE 900 may be configured to or operable to support transmitting an indication of an SRS configuration, and receiving at least one SRS on an SRS resource associated with the SRS configuration, where the at least one SRS is precoded based on an uplink precoder matrix associated with the at least one subset of resources, the uplink precoder matrix based on the capability and the at least one NZP downlink reference signal resource. This aspect improves channel sounding efficiency by enabling precoded SRS transmissions that leverage reciprocity-based precoder selection, reducing network overhead for uplink signaling.

Additionally, or alternatively, the NE 900 may be configured to or operable to support transmitting an uplink scheduling message indicating the at least one subset of resources and the indication of the SRS resource corresponding to the at least one precoded SRS, and receiving uplink data on the at least one subset of resources, where the uplink data is precoded based on the uplink precoder matrix. This aspect enables coordinated uplink data transmission with optimized precoding, improving data reliability and spectral efficiency. Additionally, or alternatively, the NE 900 may be configured to or operable to support where at least a portion of an uplink channel over which an uplink symbol on an uplink antenna port is conveyed is inferable based on at least a portion of a downlink channel over which a downlink symbol on a downlink antenna port is conveyed. This aspect reduces uplink reference signal overhead by enabling channel inference from downlink measurements, improving overall system efficiency. Additionally, or alternatively, the NE 900 may be configured to or operable to support where a phase difference between the portion of the uplink channel and the portion of the downlink channel is a constant offset within a time window. This aspect ensures stable reciprocity-based channel estimation by maintaining predictable phase relationships, improving precoding accuracy and transmission reliability. Additionally, or alternatively, the NE 900 may be configured to or operable to support where a relative phase difference of the portion of the uplink channel between any two uplink antenna ports compared to a relative phase difference of the portion of the downlink channel between any two downlink antenna ports is below a threshold of a maximum allowable difference of relative phase error within a time window from a last received NZP downlink reference signal resource. This aspect ensures accurate multi-antenna precoding by controlling phase calibration errors, enhancing beamforming performance and signal quality. Additionally, or alternatively, the NE 900 may be configured to or operable to support where a relative power difference of the portion of the uplink channel between any two uplink antenna ports compared to a relative power difference of the portion of the downlink channel between any two downlink antenna ports is below a threshold of a maximum allowable difference of relative power error within a time window from a last received NZP downlink reference signal resource. This aspect ensures accurate power calibration across antenna ports, improving transmission efficiency and reducing interference. Additionally, or alternatively, the NE 900 may be configured to or operable to support where the partial DL-UL reciprocity includes a reciprocity calibration for a set of multiple antenna ports or a subset of the set of multiple antenna ports. This aspect enables flexible calibration configurations that accommodate varying hardware capabilities, improving system adaptability and performance across different UE implementations. Additionally, or alternatively, the NE 900 may be configured to or operable to support where the reporting configuration further includes an indication of an interference measurement resource configuration, and the value indicating the reporting quantity is based on the capability, the at least one NZP downlink reference signal resource, and the interference measurement resource configuration. This aspect enables interference-aware resource selection, improving transmission reliability and reducing interference impact on uplink communications.

Additionally, or alternatively, the NE 900 may be configured to or operable to support where the reporting configuration includes an indication to generate and transmit the report periodically or semi-persistently with a configured periodicity. This aspect enables efficient channel tracking through periodic reporting, maintaining accurate CSI while balancing signaling overhead. Additionally, or alternatively, the NE 900 may be configured to or operable to support transmitting an indication that activates the reporting configuration, where the activation of the reporting configuration initiates generation and transmission of the report. This aspect enables dynamic control of reporting behavior, reducing unnecessary signaling when reciprocity-based reporting is not needed. Additionally, or alternatively, the NE 900 may be configured to or operable to support transmitting an indication that deactivates the reporting configuration, where the deactivation of the reporting configuration stops generation and transmission of the report. This aspect conserves UE resources and reduces signaling overhead by disabling reporting when no longer required. Additionally, or alternatively, the NE 900 may be configured to or operable to support where the report is received based on a trigger condition failing to satisfy a threshold, where the trigger condition includes a downlink radio link quality associated with an NZP downlink reference signal. This aspect enables event-driven reporting that responds to channel quality changes, improving system responsiveness and ensuring timely updates when channel conditions degrade.

Additionally, or alternatively, the NE 900 may support at least one memory (e.g., the memory 904) and at least one processor (e.g., the processor 902) coupled with the at least one memory and configured to cause the NE to receive a capability message indicating a capability of a UE to support at least a partial DL-UL reciprocity, transmit, based on the capability, a reporting configuration indicating a downlink reference signal configuration and a reporting quantity, the downlink reference signal configuration indicating at least one NZP downlink reference signal resource for channel measurement, and receive a report including a value indicating the reporting quantity based on the capability, the reporting configuration, and the at least one NZP downlink reference signal resource. In this manner, the NE 900 supports improved uplink channel characteristics estimation by leveraging DL-UL reciprocity, reducing signaling overhead and enhancing spectral efficiency for uplink transmissions.

Additionally, the NE 900 may be configured to support any one or combination of where the reporting configuration further indicates an uplink configuration indicating a set of uplink resources for uplink transmissions, where the value indicating the reporting quantity is based on the capability, the at least one NZP downlink reference signal resource, and the uplink configuration, and where the reporting quantity indicates at least one subset of resources of the set of uplink resources that is preferred for the uplink transmissions. This aspect enables optimized resource selection for uplink transmissions, improving throughput and reducing latency by identifying preferred uplink resources based on channel conditions. Additionally, or alternatively, the NE 900 may be configured to or operable to support where the at least one subset of resources includes at least one of a semi-statically configured resource or a configured grant uplink resource that is preferred for the uplink transmissions. This aspect enhances transmission reliability by enabling flexible resource allocation that accommodates both scheduled and grant-free uplink transmissions.

Additionally, or alternatively, the NE 900 may be configured to or operable to support where the reporting quantity includes an indication of an uplink channel representation associated with the at least one subset of resources, where the uplink channel representation is based on the capability and the at least one NZP downlink reference signal resource. This aspect improves uplink beamforming accuracy by providing channel representation information derived from downlink measurements, enhancing overall system performance. Additionally, or alternatively, the NE 900 may be configured to or operable to support where the uplink channel representation includes at least one of a preferred uplink precoder matrix from an uplink precoder codebook or a representation of an uplink channel spatial covariance matrix. This aspect enables precise precoding selection for uplink transmissions, maximizing signal quality and improving data throughput. Additionally, or alternatively, the NE 900 may be configured to or operable to support transmitting an indication of an SRS configuration, and receiving at least one SRS on an SRS resource associated with the SRS configuration, where the at least one SRS is precoded based on an uplink precoder matrix associated with the at least one subset of resources, the uplink precoder matrix based on the capability and the at least one NZP downlink reference signal resource. This aspect improves channel sounding efficiency by enabling precoded SRS transmissions that leverage reciprocity-based precoder selection, reducing network overhead for uplink signaling.

Additionally, or alternatively, the NE 900 may be configured to or operable to support transmitting an uplink scheduling message indicating the at least one subset of resources and the indication of the SRS resource corresponding to the at least one precoded SRS, and receiving uplink data on the at least one subset of resources, where the uplink data is precoded based on the uplink precoder matrix. This aspect enables coordinated uplink data transmission with optimized precoding, improving data reliability and spectral efficiency. Additionally, or alternatively, the NE 900 may be configured to or operable to support where at least a portion of an uplink channel over which an uplink symbol on an uplink antenna port is conveyed is inferable based on at least a portion of a downlink channel over which a downlink symbol on a downlink antenna port is conveyed. This aspect reduces uplink reference signal overhead by enabling channel inference from downlink measurements, improving overall system efficiency. Additionally, or alternatively, the NE 900 may be configured to or operable to support where a phase difference between the portion of the uplink channel and the portion of the downlink channel is a constant offset within a time window. This aspect ensures stable reciprocity-based channel estimation by maintaining predictable phase relationships, improving precoding accuracy and transmission reliability. Additionally, or alternatively, the NE 900 may be configured to or operable to support where a relative phase difference of the portion of the uplink channel between any two uplink antenna ports compared to a relative phase difference of the portion of the downlink channel between any two downlink antenna ports is below a threshold of a maximum allowable difference of relative phase error within a time window from a last received NZP downlink reference signal resource. This aspect ensures accurate multi-antenna precoding by controlling phase calibration errors, enhancing beamforming performance and signal quality. Additionally, or alternatively, the NE 900 may be configured to or operable to support where a relative power difference of the portion of the uplink channel between any two uplink antenna ports compared to a relative power difference of the portion of the downlink channel between any two downlink antenna ports is below a threshold of a maximum allowable difference of relative power error within a time window from a last received NZP downlink reference signal resource. This aspect ensures accurate power calibration across antenna ports, improving transmission efficiency and reducing interference. Additionally, or alternatively, the NE 900 may be configured to or operable to support where the partial DL-UL reciprocity includes a reciprocity calibration for a set of multiple antenna ports or a subset of the set of multiple antenna ports. This aspect enables flexible calibration configurations that accommodate varying hardware capabilities, improving system adaptability and performance across different UE implementations. Additionally, or alternatively, the NE 900 may be configured to or operable to support where the reporting configuration further includes an indication of an interference measurement resource configuration, and the value indicating the reporting quantity is based on the capability, the at least one NZP downlink reference signal resource, and the interference measurement resource configuration. This aspect enables interference-aware resource selection, improving transmission reliability and reducing interference impact on uplink communications.

Additionally, or alternatively, the NE 900 may be configured to or operable to support where the reporting configuration includes an indication to generate and transmit the report periodically or semi-persistently with a configured periodicity. This aspect enables efficient channel tracking through periodic reporting, maintaining accurate CSI while balancing signaling overhead. Additionally, or alternatively, the NE 900 may be configured to or operable to support transmitting an indication that activates the reporting configuration, where the activation of the reporting configuration initiates generation and transmission of the report. This aspect enables dynamic control of reporting behavior, reducing unnecessary signaling when reciprocity-based reporting is not needed. Additionally, or alternatively, the NE 900 may be configured to or operable to support transmitting an indication that deactivates the reporting configuration, where the deactivation of the reporting configuration stops generation and transmission of the report. This aspect conserves UE resources and reduces signaling overhead by disabling reporting when no longer required. Additionally, or alternatively, the NE 900 may be configured to or operable to support where the report is received based on a trigger condition failing to satisfy a threshold, where the trigger condition includes a downlink radio link quality associated with an NZP downlink reference signal. This aspect enables event-driven reporting that responds to channel quality changes, improving system responsiveness and ensuring timely updates when channel conditions degrade.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

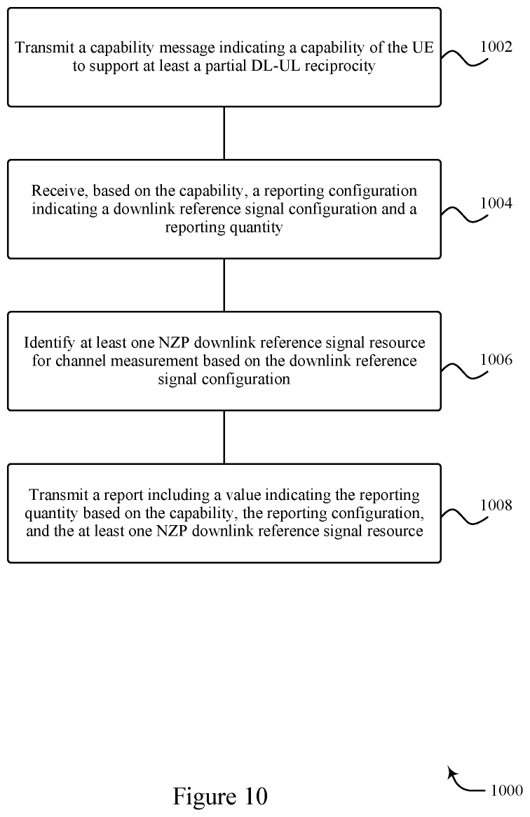

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified, and that other implementations may be possible.

At 1002, the method may include transmitting a capability message indicating a capability of the UE to support at least a partial DL-UL reciprocity. The operations of 1002 may be performed in accordance with examples as described herein. In some implementations, aspects of the operations of 1002 may be performed by a UE as described with reference to FIG. 7.

At 1004, the method may include receiving, based on the capability, a reporting configuration indicating a downlink reference signal configuration and a reporting quantity. The operations of 1004 may be performed in accordance with examples as described herein. In some implementations, aspects of the operations of 1004 may be performed by a UE as described with reference to FIG. 7.

At 1006, the method may include identifying at least one NZP downlink reference signal resource for channel measurement based on the downlink reference signal configuration. The operations of 1006 may be performed in accordance with examples as described herein. In some implementations, aspects of the operations of 1006 may be performed by a UE as described with reference to FIG. 7.

At 1008, the method may include transmitting a report including a value indicating the reporting quantity based on the capability, the reporting configuration, and the at least one NZP downlink reference signal resource. The operations of 1008 may be performed in accordance with examples as described herein. In some implementations, aspects of the operations of 1008 may be performed by a UE as described with reference to FIG. 7.

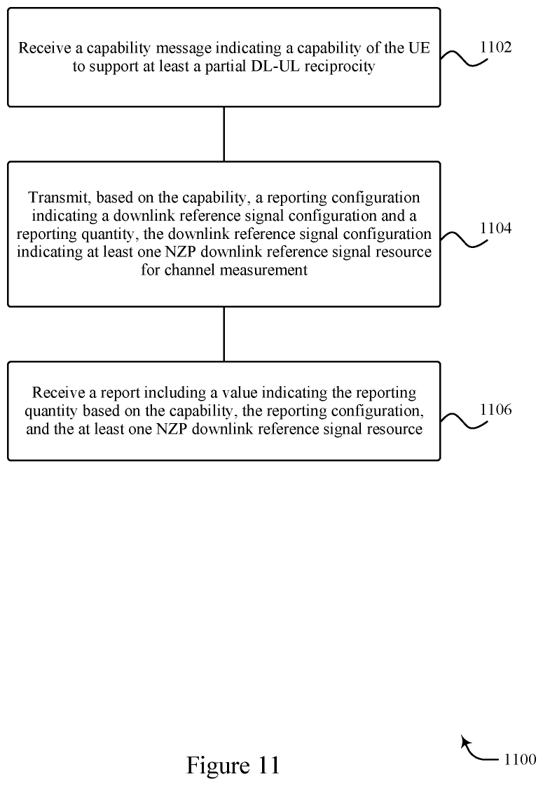

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations may be possible.

At 1102, the method may include receiving a capability message indicating a capability of the UE to support at least a partial DL-UL reciprocity. The operations of 1102 may be performed in accordance with examples as described herein. In some implementations, aspects of the operations of 1102 may be performed by an NE as described with reference to FIG. 9.

At 1104, the method may include transmitting, based on the capability, a reporting configuration indicating a downlink reference signal configuration and a reporting quantity, the downlink reference signal configuration indicating at least one NZP downlink reference signal resource for channel measurement. The operations of 1104 may be performed in accordance with examples as described herein. In some implementations, aspects of the operations of 1104 may be performed by an NE as described with reference to FIG. 9.

At 1106, the method may include receiving a report including a value indicating the reporting quantity based on the capability, the reporting configuration, and the at least one NZP downlink reference signal resource. The operations of 1106 may be performed in accordance with examples as described herein. In some implementations, aspects of the operations of 1106 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit a capability message indicating a capability of the UE to support at least a partial downlink-uplink (DL-UL) reciprocity;
receive, based at least in part on the capability, a reporting configuration indicating a downlink reference signal configuration and a reporting quantity;
identify at least one non-zero power (NZP) downlink reference signal resource for channel measurement based at least in part on the downlink reference signal configuration; and
transmit a report comprising a value indicating the reporting quantity based at least in part on the capability, the reporting configuration, and the at least one NZP downlink reference signal resource.

2. The UE of claim 1, wherein the reporting configuration further indicates an uplink configuration indicating a set of uplink resources for uplink transmissions, and wherein the at least one processor is further operable to cause the UE to:
determine the value indicating the reporting quantity based at least in part on the capability, the at least one NZP downlink reference signal resource, and the uplink configuration, wherein the reporting quantity indicates at least one subset of resources of the set of uplink resources that is preferred for the uplink transmissions.

3. The UE of claim 2, wherein the at least one subset of resources comprises at least one of a semi-statically configured resource or a configured grant uplink resource that is preferred for the uplink transmissions.

4. The UE of claim 2, wherein the reporting quantity comprises an indication of an uplink channel representation associated with the at least one subset of resources, and wherein the uplink channel representation is based at least in part on the capability and the at least one NZP downlink reference signal resource, the uplink channel representation comprising at least one of a preferred uplink precoder matrix from an uplink precoder codebook or a representation of an uplink channel spatial covariance matrix.

5. The UE of claim 2, wherein the at least one processor is further operable to cause the UE to:
receive an indication of a sounding reference signal (SRS) configuration;
determine, based at least in part on the capability and the at least one NZP downlink reference signal resource, an uplink precoder matrix associated with the at least one subset of resources; and
transmit at least one SRS on an SRS resource associated with the SRS configuration, wherein the at least one SRS is precoded based at least in part on the uplink precoder matrix.

6. The UE of claim 5, wherein the at least one processor is further operable to cause the UE to:
receive an uplink scheduling message indicating the at least one subset of resources and the indication of the SRS resource corresponding to the at least one precoded SRS;
precode uplink data based at least in part on the uplink precoder matrix; and
transmit the precoded uplink data on the at least one subset of resources.

7. The UE of claim 1, wherein the at least one processor is further operable to cause the UE to infer at least a portion of an uplink channel over which an uplink symbol on an uplink antenna port is conveyed based at least in part on at least a portion of a downlink channel over which a downlink symbol on a downlink antenna port is conveyed.

8. The UE of claim 7, wherein a phase difference between the portion of the uplink channel and the portion of the downlink channel is a constant offset within a time window.

9. The UE of claim 7, wherein a relative phase difference of the portion of the uplink channel between any two uplink antenna ports compared to a relative phase difference of the portion of the downlink channel between any two downlink antenna ports is below a threshold of a maximum allowable difference of relative phase error within a time window from a last received NZP downlink reference signal resource, and
wherein a relative power difference of the portion of the uplink channel between any two uplink antenna ports compared to a relative power difference of the portion of the downlink channel between any two downlink antenna ports is below a threshold of a maximum allowable difference of relative power error within a time window from a last received NZP downlink reference signal resource.

10. The UE of claim 1, wherein the reporting configuration further comprises an indication of an interference measurement resource configuration, and wherein the at least one processor is further operable to cause the UE to:
determine, based at least in part on the capability, the at least one NZP downlink reference signal resource, and the interference measurement resource configuration, the value indicating the reporting quantity.

11. The UE of claim 1, wherein the at least one processor is further operable to cause the UE to:
receive an indication that activates the reporting configuration; and
initiate generation and transmission of the report based at least in part on the activation of the reporting configuration.

12. The UE of claim 1, wherein the at least one processor is further operable to cause the UE to:
receive an indication that deactivates the reporting configuration; and
stop generation and transmission of the report based at least in part on the deactivation of the reporting configuration.

13. The UE of claim 1, wherein the at least one processor is further operable to cause the UE to:
initiate generation and transmission of the report based at least in part on a trigger condition failing to satisfy a threshold, wherein the trigger condition comprises a downlink radio link quality associated with an NZP downlink reference signal.

14. A network equipment (NE) for wireless communication, comprising:
at least one memory; and
at least one processor coupled with the at least one memory and operable to cause the NE to:
receive a capability message indicating a capability of a user equipment (UE) to support at least a partial downlink-uplink (DL-UL) reciprocity;
transmit, based at least in part on the capability, a reporting configuration indicating a downlink reference signal configuration and a reporting quantity, the downlink reference signal configuration indicating at least one non-zero power (NZP) downlink reference signal resource for channel measurement; and
receive a report comprising a value indicating the reporting quantity based at least in part on the capability, the reporting configuration, and the at least one NZP downlink reference signal resource.

15. The NE of claim 14, wherein the reporting configuration further indicates an uplink configuration indicating a set of uplink resources for uplink transmissions, wherein the value indicating the reporting quantity is based at least in part on the capability, the at least one NZP downlink reference signal resource, and the uplink configuration, and wherein the reporting quantity indicates at least one subset of resources of the set of uplink resources that is preferred for the uplink transmissions.

16. The NE of claim 15, wherein the at least one subset of resources comprises at least one of a semi-statically configured resource or a configured grant uplink resource that is preferred for the uplink transmissions.

17. The NE of claim 15, wherein the at least one processor is further operable to cause the NE to:
transmit an indication of a sounding reference signal (SRS) configuration;
receive at least one SRS on an SRS resource associated with the SRS configuration, wherein the at least one SRS is precoded based at least in part on an uplink precoder matrix associated with the at least one subset of resources, the uplink precoder matrix based at least in part on the capability and the at least one NZP downlink reference signal resource;
transmit an uplink scheduling message indicating the at least one subset of resources and the indication of the SRS resource corresponding to the at least one precoded SRS; and
receive uplink data on the at least one subset of resources, wherein the uplink data is precoded based at least in part on the uplink precoder matrix.

18. The NE of claim 14, wherein the at least one processor is further operable to cause the NE to:
transmit an indication that activates the reporting configuration, wherein the activation of the reporting configuration initiates generation and transmission of the report; and
transmit an indication that deactivates the reporting configuration, wherein the deactivation of the reporting configuration stops generation and transmission of the report.

19. A method performed by a user equipment (UE), the method comprising:
transmitting a capability message indicating a capability of the UE to support at least a partial downlink-uplink (DL-UL) reciprocity;
receiving, based at least in part on the capability, a reporting configuration indicating a downlink reference signal configuration and a reporting quantity;
identifying at least one non-zero power (NZP) downlink reference signal resource for channel measurement based at least in part on the downlink reference signal configuration; and
transmitting a report comprising a value indicating the reporting quantity based at least in part on the capability, the reporting configuration, and the at least one NZP downlink reference signal resource.

20. A method performed by a network equipment (NE), the method comprising:
receiving a capability message indicating a capability of a user equipment (UE) to support at least a partial downlink-uplink (DL-UL) reciprocity;
transmitting, based at least in part on the capability, a reporting configuration indicating a downlink reference signal configuration and a reporting quantity, the downlink reference signal configuration indicating at least one non-zero power (NZP) downlink reference signal resource for channel measurement; and
receiving a report comprising a value indicating the reporting quantity based at least in part on the capability, the reporting configuration, and the at least one NZP downlink reference signal resource.
